(19) United States
(12) Patent Application Publication
(10) Pub. No.: US 2026/0330691 A1
(43) Pub. Date: Oct. 22, 2026

(54) APPLICATIONS OF LAYERED ENCODING IN SPLIT COMPUTING

(71) Applicant: V-NOVA INTERNATIONAL LIMITED, London (GB)

(72) Inventor: Guido MEARDI, London (GB)

(21) Appl. No.: 18/880,786

(22) PCT Filed: Jun. 30, 2023
(86) PCT No.: PCT/GB2023/051730

§ 371 Date: Jan. 2, 2025

(30) Foreign Application Priority Data
Jul. 1, 2022 (GB) 2209740.6
Jul. 4, 2022 (GB) 2209821.1
Jul. 5, 2022 (GB) 2209897.4
Jul. 15, 2022 (GB) 2210438.4

(51) Int. Cl. G06T 9/00; H04N 19/172; H04N 19/187

(52) U.S. Cl. CPC G06T 9/001; H04N 19/172; H04N 19/187

(57) ABSTRACT

A networked system for generating a sequence of frames for rendering a dynamic 3D scene, the system comprising a first rendering node and a second rendering node, wherein: the first rendering node is configured to: generate a sequence of first partially rendered data; perform layered encoding on each first partially rendered data to generate a sequence of encoded first partially rendered data; and transmit the sequence of encoded first partially rendered data to the second rendering node; and the second rendering node is configured to: obtain the sequence of encoded first partially rendered data from the first rendering node; and generate a sequence of second partially or fully rendered frames based on the sequence of encoded first partially rendered data.

### TECHNICAL FIELD

The following disclosure relates to systems in which images are generated and displayed on a display device. The images may for example virtually represent objects in a 3D space. The display device may for example be a user eXtended Reality (“XR”, comprising Virtual Reality and/or Augmented Reality) headset, a pair of XR smart-glasses, an auto-stereoscopic display, a TV display, a mobile device, a PC, etc.

### BACKGROUND

According to so-called “split computing” or “remote rendering”, the images are commonly generated remotely from the display device, and there are typically limitations on the communication speed and capacity between the image source and the display device. For example, the image source and the display device may be connected via a network, and the image source may for example be located on separate device within a same room, a server in a nearby private data center or a server in the so-called cloud.

Due to the limitations on communication speed and capacity, as well as the processing speed and processing resources required for image generation, it is desirable to minimise factors such as the frame rate and the quantity of transmitted data as far as possible without compromising user experience. Furthermore, bandwidth may vary over time, and it may be desirable to promptly reduce the quantity of transmitted data when the bandwidth is reduced, so as to avoid so-called “latency jitter”. It is common in the art to adapt the resolution and/or frame rate of the video sequence transmitted to the display device, although the response time of varying resolution and frame rate typically lags the sudden drops in bandwidth (especially those of wireless transmission), and the requirement of sending a relatively large I-frame (e.g., a Intra-frame independent of preceding frames) at each change of resolution further increases the risk of latency jitter with unreliable data channels.

Additionally, due to the time required for generating an image and communicating the image to the display device, there can be a discrepancy between the display (“viewport”) that is required at the time of generation of an image and the display that is required at the time of displaying the image at the display device. By way of non-limiting example, when the display device is a user headset, the user may move their head either deliberately or unconsciously.

These issues are especially challenging when high quality 3D video (e.g. 3D mesh or point cloud) is expected, such as in the near-photorealistic graphics of modern video games, and when headsets are required to have low weight and low power consumption (e.g. 1 Watt target consumption).

One known technique for handling limited frame rates, and delays between image generation and image display, is known as reprojection, warping or time warping. Additionally, it is known to use depth maps to assist with representing a 3D space. A depth map indicates how far different surfaces of 3D objects, or different parts of an image, should appear to be from the viewer. Depth maps may be used in time warping (which in such depth-assisted case can take parallax into account, and is thus often called “space warping”) as well as other real-time display adjustments such as varifocal corrections based on eye tracking. Although depth maps are often used to assist with space warping when rendering is performed locally within a same device and accurate depth information is directly available, it is currently challenging to efficiently transmit compressed depth information at a sufficient bit-depth granularity when rendering is performed according to split computing methods, in particular due to the fact that bandwidth is scarce, computing power is limited, and available hardware-accelerated methods to compress image and video data provide maximum pixel data accuracy of 10 bit values, and thus are relatively inaccurate for the purpose of depth information.

By making the video streaming component of split computing more efficient, it is conceivable that the use cases supported by split computing will increase, thus highlighting the need to make the rendering process as efficient as possible. It has been proposed that, according to so-called “hybrid rendering”, the rendering process itself may further be split across multiple servers, not necessarily co-located, for example by performing costly calculations on one server and then finalizing viewport rendering on another lower-power device closer to the user. A known problem in the art is how to suitably perform hybrid rendering and then efficiently compress and transmit the intermediate by-products to the device performing final rendering of the viewport.

### SUMMARY

According to a first aspect, the present disclosure provides a networked system for generating a sequence of frames for rendering a dynamic 3D scene, the system comprising a first rendering node and a second rendering node, wherein: the first rendering node is configured to: generate a sequence of first partially rendered frames; perform encoding (in particular, as a non-limiting example, layered encoding) on each first partially rendered frame to generate a sequence of encoded first partially rendered frames; and transmit the sequence of encoded first partially rendered frames to the second rendering node; and the second rendering node is configured to: obtain the sequence of encoded first partially rendered frames from the first rendering node; and generate a sequence of second partially or fully rendered frames based on the sequence of encoded first partially rendered frames .. For example, the first rendering may be a node of a distributed rendering network, and the second rendering node may be another node of the distributed rendering network, or may be a user device, such as a VR headset. The first rendering node may be a central node, and the second rendering node may be an edge node. Rendering nodes may serve multiple users, and the first rendering node may serve more users than the second rendering node.

Optionally for the first aspect, the second rendering node is configured to decode the sequence of encoded first partially rendered frames to obtain the sequence of first partially rendered frames.

Optionally for the first aspect, the second rendering node is configured to perform layered encoding on each second partially or fully rendered frame to generate a sequence of encoded second partially or fully rendered frames.

In one embodiment, the first rendering node is configured to perform layered encoding according to a first coding scheme, and the second rendering node is configured to perform layered encoding according to a second coding scheme, the first coding scheme being different from the second coding scheme.

Optionally for the first aspect, a frame rate for the sequence of second partially or fully rendered frames is greater than a frame rate for the sequence of first partially rendered frames. In a non-limiting embodiment, this is achieved by the partially rendered frames comprising data to be processed while performing frame rate interpolations, to support more accurate interpolations.

Optionally for the first aspect, the first rendering node generates the sequence of first partially rendered frames comprising a first data type and the second rendering node generate the sequence of second partially or fully rendered frames comprising a second data type, wherein the first data type is different from the first data type. For example, the first data type may be point cloud data, and the second data type may be image data, wherein the image data is generated at least partly based on the point cloud data.

Optionally for the first aspect, the system comprises a display device, wherein a communication delay between the first rendering node and the display device is larger than a communication delay between the second rendering node and the display device.

In one embodiment: the first rendering node is configured to obtain a viewing position from the display device before generating the sequence of first partially rendered frames; and the second rendering node is configured to obtain an updated viewing position from the display device before generating the sequence of second partially or fully rendered frames.

Optionally for the first aspect, generating the sequence of first partially rendered frames requires greater processing resources than generating the sequence of second partially or fully rendered frames.

Optionally for the first aspect, each frame comprises image data and depth map data, and the system comprises a third rendering node configured to generate a sequence of third fully rendered frames by performing time warping and/or depth correction on the sequence of second partially or fully rendered frames using the depth map data. For example, the first rendering node and second rendering node may be nodes of a distributed rendering network, and the third rendering node may be a user device, such as a VR headset. The first rendering node may be a central node, and the second rendering node may be an edge node. Rendering nodes may serve multiple users, and the first rendering node may serve more users than the second rendering node.

Optionally for the first aspect, each frame comprises point cloud data in which each of a plurality of points has a 3D position and one or more attributes.

When each frame comprises point cloud data, the second or third rendering node may be configured to calculate depth map data based on 3D positions of points. Optionally for the first aspect, the first rendering node is configured to generate one or more sequences of first partially rendered frames, for a first number of users or display devices; and the second rendering node is configured to generate one or more sequences of second partially or fully rendered frames, for a second number of the plurality of users or display devices, wherein the second number is smaller than the first number.

Optionally for the first aspect, the networked system dynamically chooses how many nodes and what specific nodes will be used for the rendering process responsive to at least one metric comprising a metric of complexity of the rendering task to be performed, the spare capacity available in each node, the location of the display device with respect to the network of nodes, the roundtrip latency between nodes and display device, the bandwidth available among nodes and from nodes to display device, the number of distinct display devices requesting rendering of a same 3D scene within a range of point of views.

Optionally for the first aspect, the partially rendered frame is encoded as volumetric data comprising by way of non-limiting example point cloud data, mesh data and/or texture data, allowing the subsequent rendering node(s) to render multiple points of view within a range (“zone of view”), and the partially rendered frame is used by one or more subsequent rendering nodes to produce fully rendered frames for at least two users. This allows to compute processing-intensive aspects of the scene only once for multiple users.

Optionally for the first aspect, the partially rendered frame comprises light field data, allowing to compute those environmental properties only once for multiple users in the same virtual environment.

Optionally for the first aspect, the partially rendered frame comprises spatial properties allowing to compute the behaviour of sound in the 3D space, allowing to compute those properties only once for multiple users in the same virtual environment.

Optionally for the first aspect, the partially rendered frame is encoded by using at least in part lossy encoding methods.

Optionally for the first aspect, the partially rendered frame is encoded by using at least in part layered encoding methods.

Optionally for the first aspect, a subsequent node receives only a portion of the data encoded by the first rendering node, responsive to the specific location of the one or more points of view of the fully rendered frames to be computed.

Optionally for the first aspect, a subsequent node only decodes the subset of encoded data produced by the first rendering node and received by the subsequent node that are necessary to fully render the specific field of view that it is rendering at any one point.

Optionally for the first aspect, the partially rendered frame is encoded by using at least in part a point cloud format representing points according to one or more coordinate systems, each point being attributed one or more data attributes specifying visual properties comprising one or more of size, normal vector, motion information, colour information, transparency.

According to an aspect related to the first aspect, the disclosure provides a method of generating a sequence of frames for rendering a dynamic 3D scene, wherein: a first rendering node of a networked system: generates a sequence of first partially rendered frames; performs encoding (in particular, as a non-limiting example, layered encoding) on each first partially rendered frame to generate a sequence of encoded first partially rendered frames; and transmits the sequence of encoded first partially rendered frames to a second rendering node of the networked system; and the second rendering node: obtains the sequence of encoded first partially rendered frames from the first rendering node; and generates a sequence of second partially or fully rendered frames based on the sequence of encoded first partially rendered frames. The optional features of the first aspect may be applied to the related aspect.

According to an aspect related to the first aspect, the disclosure provides a bitstream comprising a sequence of encoded first partially rendered frames. The bitstream is generated by a first rendering node by: generating a sequence of first partially rendered frames; and performing encoding (in particular, as a non-limiting example, layered encoding) on each first partially rendered frame to generate a sequence of encoded first partially rendered frames. The bitstream is suitable for a second rendering node to generate a sequence of second partially or fully rendered frames based on the sequence of encoded first partially rendered frames. The optional features of the first aspect may be applied to the related aspect.

According to a second aspect, the disclosure provides a method for encoding a sequence of frames representing a dynamic 3D scene, wherein each frame comprises base-layer image data and enhancement data, the method comprising: performing layered encoding on a frame of the sequence of frames to generate an encoded frame comprising a base image layer and an enhancement image layer.

Optionally for the second aspect, the enhancement image layer comprises data used by the decoder device to reconstruct a higher resolution rendition of the sequence of frames.

Optionally for the second aspect, the enhancement image layer comprises data used by the decoder device to reconstruct a higher bit-depth rendition of the sequence of frames with respect to the bit-depth of the base image layer.

Optionally for the second aspect, the enhancement image layer comprises data used by the decoder device to reconstruct the distance of objects in the image from the viewer.

Optionally for the second aspect, the enhancement image layer comprises data used by the decoder device to reconstruct haptic feedback for the user.

Optionally for the second aspect, the method further comprising: responsive to a drop in transmission channel bandwidth, discarding enhancement data during transmission of the sequence of frames and indicating to the encoder that the enhancement data has been dropped, and if the enhancement data is being dropped, refreshing temporal buffers of enhancement data encoding and performing an Instantaneous Decoder Refresh (IDR) for the enhancement data (not necessarily for the base layer data), to account for the decoder having missed some of the previous enhancement data.

Optionally for the second aspect, the layered encoding method used is MPEG-5 LCEVC (Low Complexity Enhancement Video Coding) encoding or SMPTE VC-6 encoding.

Optionally for the second aspect, at least one of the enhancement data being transmitted as embedded user data within the coefficients of LCEVC data. By way of non-limiting example, one or more residual coefficients of an image comprise embedded depth information representing the depth of the corresponding object with respect to the viewpoint, and the decoder processes the embedded data to reconstruct a depth map associated to the image frame based at least in part on the embedded data. In a non-limiting embodiment, the depth map is reconstructed by processing both the embedded data and the image data.

Optionally for the second aspect, or as a stand-alone implementation, the frame plus depth data sent at a given frame rate are used by the display device to increase the frame rate via space warping (depth-based reprojections) so as to match the display frame rate, thus enabling the rendering and video streaming processes to be performed at a frame rate lower than the display frame rate and reducing the bandwidth and processing resources required.

Optionally for the second aspect, each frame comprises image data and depth map data, and the method comprises performing layered encoding on a frame of the sequence of frames to generate an encoded frame comprising one or more of a base depth map layer and an enhancement depth map layer.

Optionally for the second aspect, each frame comprises an image layer and a depth map layer, and the encoded frame comprises a base image layer, the base depth map layer, an enhancement image layer and the enhancement depth map layer.

Optionally for the second aspect, each frame comprises the depth map data embedded in the image data, the base depth map layer is a base image layer with embedded depth map data, and the enhancement depth map layer is an enhancement image layer with embedded depth map data.

Optionally for the second aspect, the method further comprises: receiving a depth map drop indication indicating whether or not the depth map data is being dropped when transmitting the sequence of frames; and if the depth map data is being dropped and available bandwidth is lower than a threshold, discarding the depth map data of a frame, and performing layered encoding on the image data of the frame to generate an encoded frame comprising a base image layer and an enhancement image layer.

According to an aspect related to the second aspect, the disclosure provides an encoder configured to encode a sequence of frames representing a dynamic 3D scene, wherein each frame comprises base-layer image data and enhancement data, the encoder specifically configured to perform layered encoding on a frame of the sequence of frames to generate an encoded frame comprising a base image layer and an enhancement image layer. The optional features of the second aspect may be applied to the related aspect.

According to an aspect related to the second aspect, the disclosure provides a bitstream comprising an encoded sequence of frames representing a dynamic 3D scene, wherein each frame comprises a base image layer and an enhancement image layer.

According to a third aspect, the disclosure provides a method for decoding a sequence of frames representing a dynamic 3D scene, wherein each frame comprises base-layer image data and enhancement data, the method comprising: performing layered decoding on a frame of the sequence of frames to generate an decoded frame from a base image layer and an enhancement image layer.

Optionally for the third aspect, the enhancement image layer comprises data used in the decoding method to reconstruct a higher resolution rendition of the sequence of frames.

Optionally for the third aspect, the enhancement image layer comprises data used in the decoding method to reconstruct a higher bit-depth rendition of the sequence of frames with respect to the bit-depth of the base image layer.

Optionally for the third aspect, the enhancement image layer comprises data used in the decoding method to reconstruct the distance of objects in the image from the viewer.

Optionally for the third aspect, the enhancement image layer comprises data used in the decoding method to reconstruct haptic feedback for the user.

Optionally for the third aspect, the method further comprising: sending an indication that the enhancement data should be dropped.

Optionally for the third aspect, the layered decoding method used is MPEG-5 LCEVC (Low Complexity Enhancement Video Coding) encoding or SMPTE VC-6 encoding.

Optionally for the third aspect, at least one of the enhancement data is received as embedded user data within the coefficients of LCEVC data. By way of non-limiting example, one or more residual coefficients of an image comprise embedded depth information representing the depth of the corresponding object with respect to the viewpoint, and the decoder processes the embedded data to reconstruct a depth map associated to the image frame based at least in part on the embedded data. In a non-limiting embodiment, the depth map is reconstructed by processing both the embedded data and the image data.

Optionally for the third aspect, or as a stand-alone implementation, the frame plus depth data sent at a given frame rate are used by the display device to increase the frame rate via space warping (depth-based reprojections) so as to match the display frame rate, thus enabling the rendering and video streaming processes to be performed at a frame rate lower than the display frame rate and reducing the bandwidth and processing resources required.

Optionally for the third aspect, each frame comprises image data and depth map data, and the method comprises performing layered decoding on a frame of the sequence of frames to generate an encoded frame comprising one or more of a base depth map layer and an enhancement depth map layer.

Optionally for the third aspect, each frame comprises an image layer and a depth map layer, and the encoded frame comprises a base image layer, the base depth map layer, an enhancement image layer and the enhancement depth map layer. Optionally for the third aspect, each frame comprises the depth map data embedded in the image data, the base depth map layer is a base image layer with embedded depth map data, and the enhancement depth map layer is an enhancement image layer with embedded depth map data.

Optionally for the third aspect, the method further comprises: sending a depth map drop indication indicating that depth map data should be dropped when transmitting the sequence of frames; and if the depth map data is being dropped, performing layered decoding on the image data of the frame to generate a decoded frame from the base image layer and the enhancement image layer.

In an aspect related to the third aspect, the following disclosure provides a decoder or a display device configured to perform a method according to the third aspect. The optional features of the third aspect may be applied to the related aspect.

According to a fourth aspect, the disclosure provides a method for encoding a sequence of frames representing a dynamic 3D scene, wherein each frame comprises image data and further data, the method comprising: performing layered encoding on a frame of the sequence of frames to generate an encoded frame comprising a base layer and an enhancement layer. In particular, according to embodiments of the fourth aspect, the disclosure provides a method for encoding a sequence of frames representing a dynamic 3D scene, wherein each frame comprises image data and depth map data, the method comprising: performing layered encoding on a frame of the sequence of frames to generate an encoded frame comprising a base depth map layer and an enhancement depth map layer.

In an aspect related to the fourth aspect, the following disclosure provides an encoder or a renderer configured to perform a method according to the fourth aspect. The optional features of the fourth aspect may be applied to the related aspect.

According to a fifth aspect, the disclosure provides a method for decoding a sequence of frames representing a dynamic 3D scene, wherein each frame comprises image data and depth map data, the method comprising identifying one or more object areas in the image from the image data and assigning depth information to each of the one or more object areas in the image based on the depth map data. In some embodiments, the depth map data comprises a base depth map layer and an enhancement depth map layer, and decoding each frame comprises performing layered decoding using the image data, the base depth map layer and the enhancement depth map layer.

In an aspect related to the fifth aspect, the following disclosure provides a decoder or a display device configured to perform a method according to the fifth aspect. The optional features of the fifth aspect may be applied to the related aspect.

According to a sixth aspect, the following disclosure provides a method comprising: receiving a frame plus depth data at a given frame rate, encoded by means of a layered encoding method; and at a display device, increasing the frame rate via depth-based reprojections using the depth data so as to match a display frame rate.

Optionally for the sixth aspect, the frame comprises data representing a dynamic 3D scene, and each frame comprises base-layer image data and enhancement data. Optionally for the sixth aspect, the method comprises: performing layered decoding on a frame of the sequence of frames to generate a decoded frame from an encoded frame comprising a base image layer and an enhancement image layer.

In an aspect related to the sixth aspect, the following disclosure provides a decoder or a display device configured to perform a method according to the sixth aspect. The optional features of the sixth aspect may be applied to the related aspect.

According to a seventh aspect, the present disclosure provides a bit sequence representing an encoding of a sequence of frames representing a dynamic 3D scene, the bit sequence comprising: encoded data for a base depth map layer for a frame; and encoded data for an enhancement depth map layer for the frame.

Optionally for the seventh aspect, the bit sequence further comprises: encoded data for a base image layer for the frame; and encoded data for an enhancement image layer for the frame.

Optionally for the seventh aspect, the base depth map layer is a base image layer with embedded depth map data, and the enhancement depth map layer is an enhancement image layer with embedded depth map data.

According to a eighth aspect, the present disclosure provides a method for transmitting a sequence of frames representing a dynamic 3D scene, wherein each frame comprises image data and depth map data, the method comprising: obtaining an encoded frame comprising a base depth map layer and an enhancement depth map layer; determining if the depth map data is to be dropped when transmitting the sequence of frames; if the depth map data is to be dropped: discarding the depth map data from the encoded frame, to give a reduced encoded frame comprising a base image layer and an enhancement image layer; and transmitting the reduced encoded frame; and otherwise, transmitting the encoded frame.

Optionally for the eighth aspect: each frame comprises an image layer and a depth map layer, the encoded frame comprises a base image layer, the base depth map layer, an enhancement image layer and the enhancement depth map layer, and discarding the depth map data comprises discarding the enhancement depth map layer, and preferably further comprises discarding the base depth map layer.

Optionally for the eighth aspect: each frame comprises the depth map data embedded in the image data, the base depth map layer is a base image layer with embedded depth map data, and the enhancement depth map layer is an enhancement image layer with embedded depth map data, and discarding the depth map data comprises removing the embedded depth map data from the enhancement image layer, and preferably further comprises removing the embedded depth map data from the base image layer.

Optionally for the eighth aspect, the method further comprises: generating a depth map drop indication indicating whether or not the depth map data is being dropped when transmitting the sequence of frames; and sending the depth map drop indication to an upstream encoder, or sending the depth map drop indication with the encoded frame or the reduced encoded frame.

In an aspect related to the eighth aspect, the following disclosure provides a transmitter configured to perform a method according to the eighth aspect. The optional features of the eighth aspect may be applied to the related aspect.

According to a ninth aspect, the following disclosure provides a method performed by an encoder for encoding a sequence of frames, the method comprising: performing layered encoding on a first frame of the sequence of frames to generate a first encoded frame comprising a base layer and an enhancement layer; storing a component of the enhancement layer of the first encoded frame in a temporal buffer, for use in temporal encoding of a subsequent frame; sending the first encoded frame to a transmitter for transmission; receiving an enhancement drop indication indicating whether or not the enhancement layer was dropped when transmitting the first encoded frame; performing layered encoding on a second frame of the sequence of frames to generate a second encoded frame comprising a base layer and an enhancement layer, wherein: if the enhancement drop indication indicates that the enhancement layer was not dropped, the enhancement layer of the second encoded frame is generated with reference to the temporal buffer, and if the enhancement drop indication indicates that the enhancement layer was dropped, the enhancement layer of the second encoded frame is generated without reference to the temporal buffer.

Optionally for the ninth aspect, the method further comprises, if the enhancement drop indication indicates that the enhancement layer was dropped, clearing the temporal buffer.

Optionally for the ninth aspect, the method further comprises: if no enhancement drop indication is received within a predetermined time limit, performing layered encoding on a second frame of the sequence of frames to generate a second encoded frame comprising a base layer and an enhancement layer, wherein the enhancement layer of the second encoded frame is generated with reference to the temporal buffer.

Optionally for the ninth aspect, the method further comprises: if no enhancement drop indication is received within a predetermined time limit, performing layered encoding on a second frame of the sequence of frames to generate a second encoded frame comprising a base layer and an enhancement layer, wherein the enhancement layer of the second encoded frame is generated without reference to the temporal buffer.

Optionally for the ninth aspect, generating the enhancement layer of a frame without reference to the temporal buffer comprises: decoding the base layer of the encoded frame; and calculating a residual as a difference between the decoded base layer and the frame.

Optionally for the ninth aspect, generating the enhancement layer of a frame with reference to the temporal buffer comprises: decoding the base layer of the encoded frame; calculating a residual as a difference between the decoded base layer and the frame; and calculating a difference between the residual of the current frame and a corresponding residual of a previous frame stored in the temporal buffer.

Optionally for the ninth aspect, the layered encoding is LCEVC encoding.

In an aspect related to the ninth aspect, the following disclosure provides an encoder configured to perform a method according to the ninth aspect. The optional features of the ninth aspect may be applied to the related aspect.

Although various aspects (in particular, the first aspect) have been described in relation to one or more ‘frames’, it is to be understood that data being arranged in ‘frames’ is optional, it is therefore noted that data may be arranged in other formats and still be considered to form part of the present disclosure.

Different variations of different aspects may be combined in any combination. Certain aspects may be modified by omitting and/or features. Certain aspects not set out above may be provided by combining any of the individual features described in relation to any aspect, variation or implementation as set out above and/or below.

Any of the above-described methods may be performed by one or more processors executing a computer program. The computer program comprises computer-readable instructions which, when executed by the processors, cause the processors to perform the corresponding method. The computer-readable instructions may be stored in a non-transitory computer readable medium. The computer-readable instructions may be encoded in a digital signal such as an optical signal or an electrical signal.

Additionally, for any of the above-described methods that produce or consume an encoded sequence of frames, the encoded sequence of frames may be isolated as a bitstream, which can be transmitted to a final destination for consumption by a user shortly after rendering or after encoding, or can be stored in memory for an indefinite period, For example, a bitstream may be stored by a streaming service as part of a video-on-demand service.

### BRIEF DESCRIPTION OF THE DRAWINGS

FIG. 1 schematically illustrates display of a sequence of frames representing a dynamic 3D scene, without using depth maps;

FIG. 2 schematically illustrates display of a sequence of frames representing a dynamic 3D scene, using depth maps;

FIG. 3 schematically illustrates a networked system for generating a sequence of frames for rendering a dynamic 3D scene;

FIGS. 4A and 4B schematically illustrate features of LCEVC encoding and decoding which are relevant to the invention;

FIG. 5 is a schematic example of hierarchical decoding;

FIG. 6 is a schematic example of a residual map;

FIG. 7 is a schematic illustration of parallel processing in LCEVC, by comparison to a fully-serial coding scheme;

FIG. 8 is a schematic illustration of key features of VC-6 decoding.

FIG. 9 is a schematic illustration of an example configuration for a content rendering network.

### DETAILED DESCRIPTION

Non-limiting example embodiments disclosed herein provide methods to structure rendering resources in a hierarchy of possible available resources (which are defined herein as “Content Rendering Networks” or “CRNs”, by analogy with Content Delivery Networks providing tiered caching infrastructure for Web content). According to real-time metrics comprising by way of non-limiting example the expected processing load of the rendering to be performed, the state of available resources in the CRNs, the network latency currently present from resources in the CRNs and the number of other users requesting a rendering of the same 3D space from a point of view within a range, the CRN can dynamically select one or more resources to perform the rendering process and—when it is optimal to do so—can efficiently pool costly rendering computations to be performed once for multiple users, and then distribute compressed by-products to another resource (either another node of the CRN or a user device) that performs rendering of the final viewport and streaming to the display device.

Additional non-limiting example embodiments disclosed herein provide methods to optimize the transmission of ultra-low latency video frames by means of layered encoding methods, i.e., methods that comprise a layer of data representing the signal at a lower level of quality and one or more additional layers of data comprising information to reconstruct a rendition of the signal at a higher level of quality. By way of non-limiting example, additional layers of data allow the decoder device to enhance one or more quality aspects of the signal comprising visual fidelity, resolution, image data bit-depth (e.g., for high-nits HDR), frame rate, stereoscopy, focal distance (e.g., for varifocal adjustments), haptics, etc. One or more of the additional data layers can be treated as optional and can be safely dropped after encoding even in the midst of their transmission without compromising the quality of the base layer data, and without requiring the transmission of costly base layer I-frames (since only an IDR of enhancement data, typically much smaller, will be required). As such, layered encoding allows to transmit an enhanced video within a same bandwidth, but also importantly to provide additional degrees of freedom in how to degrade quality when bandwidth is scarce as well as faster dynamic adaptations to bandwidth drops.

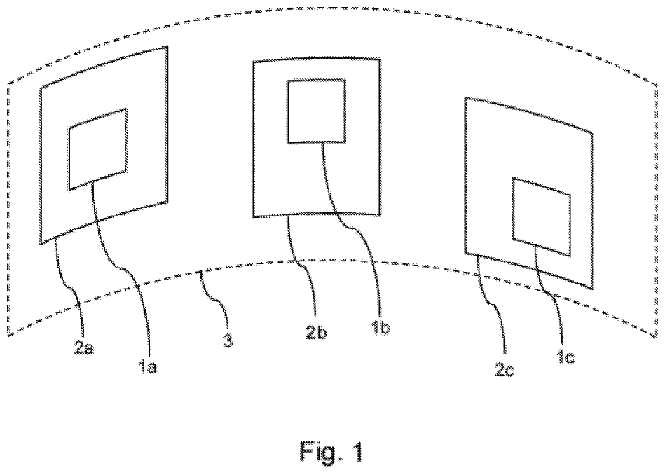

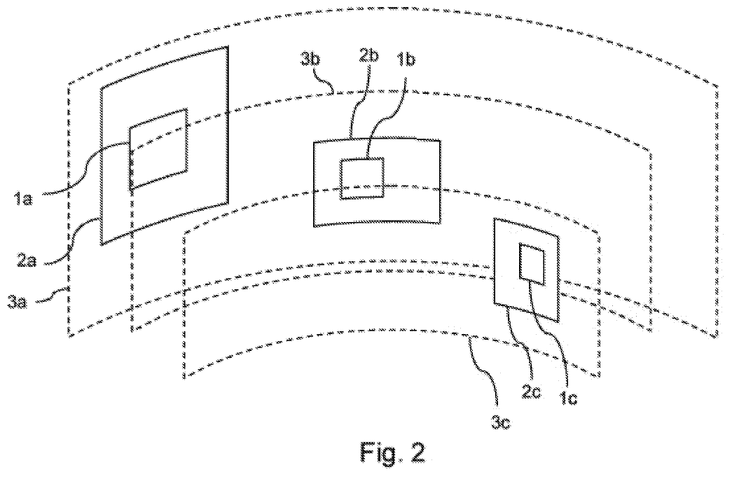

FIGS. 1 and 2 schematically illustrate the use of depth maps and warping when generating and displaying a dynamic 3D scene.

In FIGS. 1 and 2, a plurality of image portions 1a, 1b, 1c are shown. These may be displayed at the same time, as part of an overall image.

Alternatively, they may be displayed in sequence, as separate frames. In other words, image portion 1a may correspond to a frame N, image portion 1b may correspond to a frame N+1 etc.

In FIG. 1, all of the image portions are mapped to a same plane 3 when displayed. In other words, in a 3D virtual environment seen by a user through a 3D display such as a VR, XR or AR display, all of the image portions 1a, 1b, 1c are displayed as if they were at the same distance from the viewer.

On the other hand, in FIG. 2, each image portion 1a, 1b, 1c is mapped to a respective virtual plane 3a, 3b, 3c in the 3D virtual environment, which may be at a different distance from the viewer.

In a 3D environment, planes at fixed distance from the viewer are curved and planes at different distances have different curvature. As a result, various visual effects such as time warping and focal length adjustment (which may be localised or varifocal, and which may be used in response to eye tracking) behave differently depending on the distance between the viewer and the image portion. As such, by incorporating information about the distance between image portions and the viewer, a 3D environment can be rendered more realistically.

Such information about the distance from the viewer may be incorporated into frames using a depth map. In the case of a planar image portion, a depth may be specified for each pixel or block of the image portion. Alternatively, when a frame comprises point cloud information, or other information about the location of points or objects in the 3D virtual environment, this information can be used as an equivalent to a depth map when performing visual effect calculations.

FIGS. 1 and 2 additionally illustrate features of time warping. As shown in FIGS. 1 and 2, each of the displayed images 1a, 1b, 1c is a portion of the area of a warpable image 2a, 2b, 2c. Due to the delay between rendering and displaying a frame, the warpable image 2a, 2b, 2c is rendered before a most up to date viewing direction of the user is known. The warpable image 2a, 2b, 2c may be transmitted to a display device, or to a rendering node which is near to the display device, and the display device or rendering node may perform time warping to generate the displayed image portion 1a, 1b, 1c based on the corresponding warpable image 2a, 2b, 2c and the most up to date viewing direction of the user.

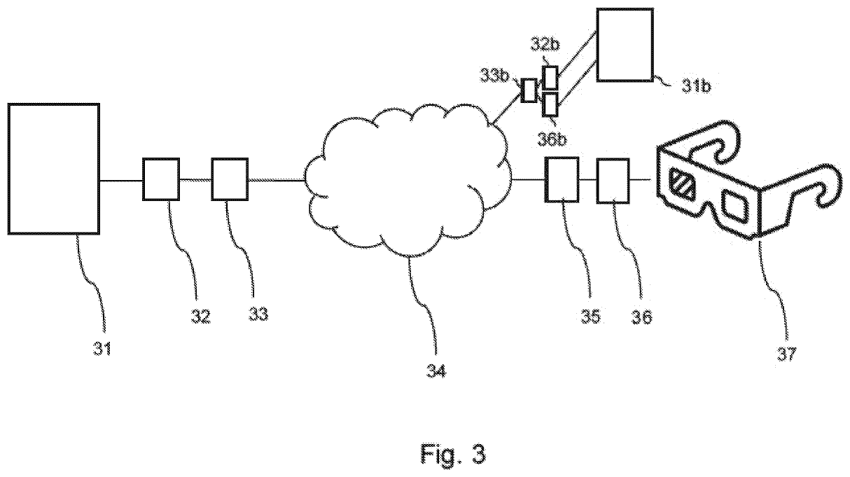

FIG. 3 schematically illustrates a system for generating an image frame sequence.

Referring to FIG. 3, the system comprises an image generator 31, an encoder 32, a transmitter 33, a network 34, a receiver 35, a decoder 36 and a display device 37.

The image generator 31, encoder 32 and transmitter 33 together form a first rendering node.

The image generator 31 may for example comprise a rendering engine for initially rendering a virtual environment such as a game or a virtual meeting room.

The image generator 31 is configured to generate a sequence of frames to be displayed. The frames may comprise one or more image portions 1a, 1b, 1c as discussed above. Additionally or alternatively, the frames may comprise point cloud data. In a point cloud, each point typically has a 3D position and one or more attributes, where the attributes may include, for example, a surface colour, a transparency value, an object size and a surface normal direction. Each attribute may have a value chosen from a continuous range or may have a value chosen from a discrete set.

Each frame may further comprise depth map data as described above. The depth map data may be provided as a depth map layer, separate from an image layer. In some contexts, such as MPEG Immersive Video (MIV), the image layer may instead be described as a texture layer. Similarly, in some contexts, the depth map layer may instead be described as a geometry layer.

Additionally, each frame may include a predicted display window location. The predicted display window location is a location of a part of the generated image 2a, 2b, 2c which is likely to be displayed by the display device 37. The predicted display window location may be based on a viewing position (such as a virtual position and/or orientation of the user in a 3D environment) of the user obtained from the display device 37. The predicted display window location may be defined using one or more coordinates. For example, referring to FIG. 1, the predicted display window location may be defined using the coordinates of a corner or center of a predicted display window, and may be defined using a size of the predicted display window. The predicted display window location may be encoded as part of metadata included with the frame.

Each frame may include further information, which may be provided as separate layers. For example, each frame may further include audio information or haptic feedback information indicating audio or haptics which can accompany displayed visual data. An audio layer or haptic layer may accompany each frame, and may be omitted for frames where no accompanying audio or haptics are required.

The frames may be based on a state of the virtual environment, a position of a user, or a viewing direction of the user. Here, the position and viewing direction may be physical properties of the user in the real-world, or position and viewing direction may also be purely virtual, for example being controlled using a handheld controller. The image generator 31 may for example obtain information from the display device 37 indicating the position, viewing direction or motion of the user. In other cases, the generated image may be independent of user position and viewing direction. This type of image generation typically requires significant computer resources such as a powerful GPU, and may be implemented in a cloud service, or on a local but powerful computer. For example, a cloud service (such as a Cloud Rendering Service (CRN)) may reduce the cost per-user and thereby make the image frame generation more accessible to a wider range of users. Here “rendering” refers at least to an initial stage of rendering to generate an image. Further rendering may occur at the display device 37 based on the generated image to produce a final image which is displayed.

The encoder 32 is configured to encode frames to be transmitted to the display device 37. The encoder 32 may be implemented using executable software or may be implemented on specific hardware such as an ASIC.

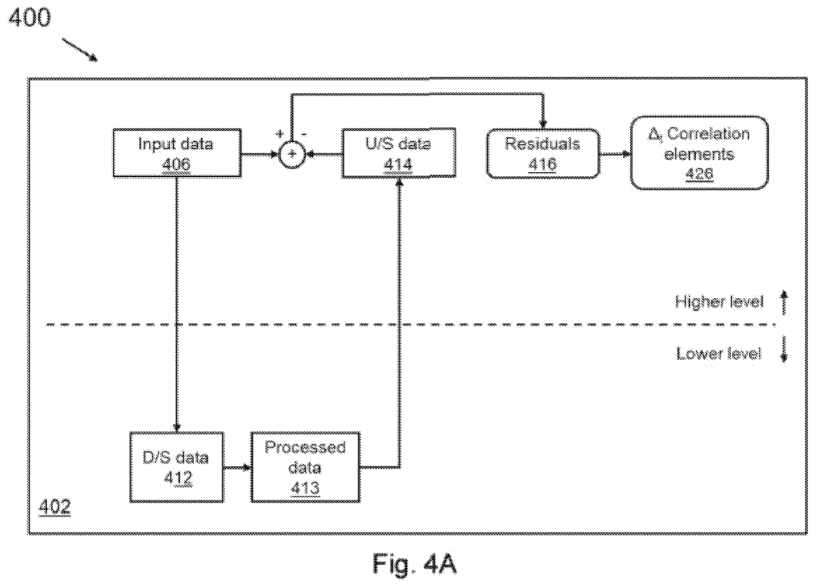

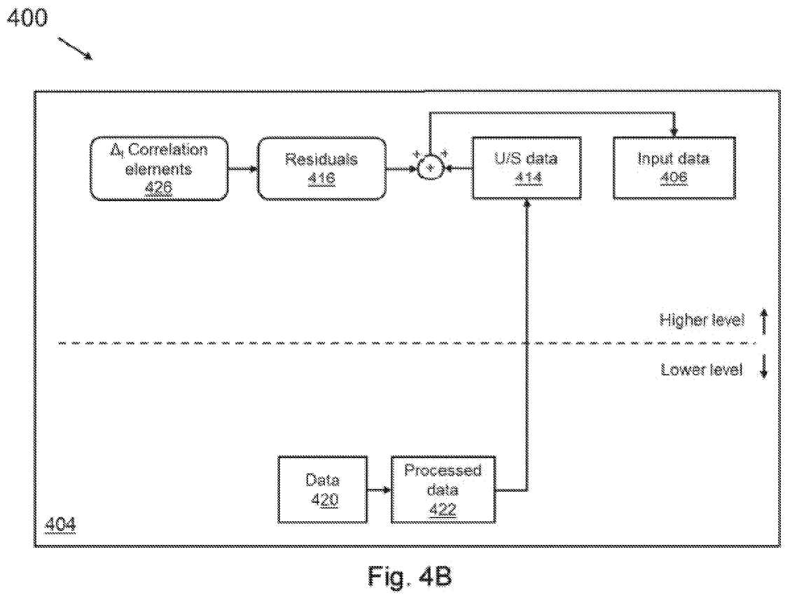

The encoder may apply inter-frame or intra-frame compression based on a currently-encoded frame and optionally one or more previously encoded frames. The encoder 32 may be a multi-layer encoder, such as an LCEVC encoder as shown in FIG. 4A, or a VC-6 encoder.

For example, when the generated frames comprise depth map data, the encoder may perform layered encoding on each frame to generate an encoded frame comprising a base depth map layer and an enhancement depth map layer. Similarly to encoding image data, encoding a depth map in this way may improve compression. In some applications, such as HDR video, depth maps are desirably highly detailed with a bit depth of up to 12 or 14 bits, which is a significant increase in the data to be transmitted. As a result, providing ways to improve compression of the depth map can make more realistic depth map-based displays viable when performing rendering or transmission of rendered data in real-time. Furthermore, this type of layered encoding makes it easy to drop (and then pick back up) one or more of the layers, which provides flexibility and tools for bandwidth management.

Layered encoding is also helpful as the final decoder/user device (such as a user display device) can choose whether to process these extra layers. For example, in a non-layered approach, the best the end device (i.e. the receiver, decoder or display device associated with a user that will view the frames) can do is determine that it does not have enough resources for a given quality (be it resolution, frame rate, inclusion of depth map) and then signal to the controller/renderer/encoder that it does not have enough resources. The controller then will send future frames at a lower quality. In that alternative scenario, the end device still unfortunately has to process the higher quality data until the lower quality data arrives, if it can process the received frames at all.

In some of the described embodiments, this situation is improved upon because when/if the end device determines for example that it does not have the processing capabilities to handle the highest level of quality, then it can drop and/or choose not to process certain layers. The end device may also signal to the controller that it needs a lower level of quality, but in the meantime the end device can only process the number of layers that it can handle. Therefore, the end device can react to conditions much more quickly.

In some cases, depth map data may be embedded in image data. In this case, the base depth map layer may be a base image layer with embedded depth map data, and the enhancement depth map layer may be an enhancement image layer with embedded depth map data.

Alternatively, when the generated frames comprise a depth map layer separate from an image layer and multi-layer encoding is applied, the encoded depth map layers may be separate from the encoded image layers. This has the advantage that the encoded depth map layers can be dropped under some conditions while still retaining image layers that can be displayed (albeit with a lower level of realism). For example, the encoded depth map layers can be dropped by a transmitter or encoder when available communication resources are reduced, or can be dropped by an end device which lacks the processing resources to handle the highest level of quality.

Similarly, if some frames comprise an audio base layer, a haptic feedback base layer, an audio enhancement layer or a haptic feedback enhancement layer, these can be processed or dropped flexibly.

Additionally or alternatively, where the frames comprise point cloud data, the encoder may apply a point cloud data encoding technique such as described in European patent application EP21386059.6, which is incorporated herein by reference. Such a point cloud encoder may act as a base encoder for a layered encoding technique such as LCEVC or VC-6. Notably LCEVC and VC-6 techniques encode and decode a layered signal, but are agnostic about the content type of data encoded in the signal. For example, the signal can include textures, video frames, geometry or depth data, meshes, point clouds, rendering attributes or physics engine attributes.

The transmitter 33 may be any known type of transmitter for wired or wireless communications, including an Ethernet transmitter or a Bluetooth transmitter.

The transmitter 33 may be configured to make decisions about how to transmit frames, and/or may provide feedback to the encoder 32 or the image generator 31. For example, the transmitter 33 may determine available communication resources (e.g. bandwidth) for transmitting frames, and may drop one or more layers from an encoded frame, or indicate to the image generator 31 and/or encoder 32 that frames should be generated and encoded with fewer layers, when insufficient bandwidth is available for transmission of all generated data. As specific examples, the transmitter 33 may be configured to drop a depth map layer, an LCEVC enhancement layer, or a VC-6 enhancement layer from a frame when insufficient communication resources are available.

The network 34 is used for communication between the transmitter 33 and the receiver 35, and may be any known type of network such as a WAN or LAN or a wireless Wi-Fi or Bluetooth network. The network 34 may further be a composite of several networks of different types. Many users only have access to a network with a bandwidth of 30 MBps which can lead to latency jitter when streaming. The required bandwidth and the observed latency can be reduced by means of tactics such as forward-looking rendering and last-millisecond reprojection, which are enabled by improved compression.

The receiver 35 may be any known type of receiver for wired or wireless communications, including an Ethernet transmitter or a Bluetooth transmitter.

The decoder 36 is configured to receive and decode an encoded frame. The decoder 36 may be implemented using executable software or may be implemented on specific hardware such as an ASIC.

The display device 37 may for example be a television screen or a VR headset. The timing of the display may be linked to a configured frame rate, such that the display device 37 may wait before displaying the image. The display device 37 may be configured to perform warping, that is, to obtain a final display window location, adjust a warpable image 2a, 2b, 2c to obtain a final image 1a, 1b, 1c corresponding to a final viewing direction of the user, and display the final image. As mentioned above, a first rendering node may comprise the image generator 31, encoder 32 and transmitter 33. Additional similar rendering nodes may be included in the system, and may work together to generate the sequence of frames.

In one case, multiple rendering nodes may each provide a part of a sequence of frames to a frame assembling node.

For example, the receiver 35, decoder 36 or display device 37 may be configured to assemble parts of a sequence of frames from multiple sources to generate the final sequence of frames for display.

Alternatively, the frame assembling node may be separate from the receiver 35, decoder 36 and display device 37.

Additionally or alternatively, multiple rendering nodes may be chained. In other words, successive rendering nodes may add components to a partial sequence of frames as it passes from rendering node to rendering node, and eventually the complete sequence of frames is provided to the receiver 35. Furthermore, each rendering node may obtain components of a render from multiple upstream rendering nodes and/or distribute components of a render to multiple downstream rendering nodes.

An example of this is shown in FIG. 3. A second rendering node comprises a transceiver 33b, a decoder 36b, an image generator 31b, and an encoder 32b. The second rendering node is configured to obtain first partially rendered frames from the first rendering node and generate second partially or fully rendered frames based on the first partially rendered frames.

The image generator 31b may be similar to the image generator 31. The image generator 31b may alternatively be called an image processor as it processes the first partially rendered frames in order to generate the second partially or fully rendered frames. The frames may comprise one or more image portions 1a, 1b, 1c as discussed above. Additionally or alternatively, the frames may comprise point cloud data.

A data type of the second partially or fully rendered frames may be different from a data type of the first partially rendered frames. For example, the first partially rendered frames may comprise point cloud data, and the second partially or fully rendered frames may comprise image data generated from the point cloud data.

Alternatively, the first partially rendered frames may comprise first image data, and the second partially or fully rendered frames may comprise second image data generated from the first image data.

Alternatively, the first partially rendered frames may comprise first point cloud data, and the second partially or fully rendered frames may comprise second point cloud data generated from the first point cloud data.

The frames generated by each rendering node may comprise multiple data types, such as a mixture of image data and point cloud data.

The second rendering node may operate on the first partially rendered frames in an encoded form (for example simply merging a first bitstream generated by the first rendering node with a second bitstream generated by the second rendering node. Alternatively, the decoder 36b may decode the first bitstream so that the image generator 31b can perform further rendering by reference to the first partially rendered frames. If the further rendering performed by the second rendering node only relates to a portion of a 2D area or 3D volume rendered by the first rendering node, or if the further rendering performed by the second rendering node only relates to some attributes of the frames rendered by the first rendering node (for example if the further rendering does not require colour information), then the decoder 36b may decode only a portion of the data encoded in the first bitstream.

Similarly, the first rendering node may not be at the beginning of a chain of rendering nodes. The first rendering node may itself obtain earlier-generated partially rendered frames from one or more upstream rendering nodes, and generate the first partially rendered frames based on the earlier-generated partially rendered frames.

A chain of rendering nodes may be useful for performing different rendering tasks that require different quantities of processing resources, or different frame rates. For example, a company may provide distributed processing in the form of a centralised hub which has abundant processing resources but is distant from users, and peripheral locations which have more scarce processing resources but are closer to users. Expensive but fairly static rendering features such as background lighting or environmental impact on sound may be generated at the central hub (for example using ray tracing), while features that require fewer resources but faster responses or higher frame rates may be generated closer to the user. In other words, the more responsive a rendering feature needs to be, the lower latency it needs between the rendering node which generates the feature and the user display and, in a chain of rendering nodes, the node which generates each rendering feature can be chosen based on a required maximum latency of that feature. On the other hand, if it is expensive to generate a rendering feature, then it may be preferable to generate the feature less frequency and with a higher maximum latency. For example, a static, high-quality background feature may generated early in the chain of rendering nodes and a dynamic, but potentially lower-quality, foreground feature may be generated later in the chain of rendering nodes, closer to the user device. Here, environmental impact on sound means, for example, a set of surfaces may be constructed where each surface has different sound reflection and absorption properties depending upon material and shape. The frame rates may be matched by creating multiple frames with features generated at the lower frame rate, and combining them with the frames with features generated at the higher frame rate. In a non-limiting embodiment, a preliminary rendering generates volumetric object data including motion vectors at a first (lowest) frame rate, then produces 2D rendered frames plus depth information for a specific user at a second (higher) frame rate, then transmits video plus depth data to the user device, which produces final frames for display via space warping (depth-based reprojections) at a third (highest) frame rate. One or more of these steps may be performed in combination with the other described embodiments. The viewing position of the user may change as additional rendering tasks are performed at different rendering nodes in the chain. Each or any rendering node may obtain an updated viewing position before performing its respective rendering task.

Additionally, the system may simultaneously generate multiple sequences of frames for different respective users or different respective display devices. For example, in the context of a VR or AR experience, each user or display device may view a different 3D environment, or may view different parts of a same 3D environment. When using a chain of rendering nodes, each node may serve multiple users or just one user.

For example, a starting rendering node (e.g. at a centralised hub) may serve a large group of users. For example, the group of users may be viewing nearby parts of a same 3D environment. In this case, the starting node may render a wide zone of view (“field of view”) which is relevant for all users in the large group.

The starting node may send this wide field of view to a first middle rendering node which renders additional aspects of the 3D environment. These additional aspects may for example be aspects which require less processing power to render, or may be aspects which are specific to individual users of the group. Additionally, the middle rendering node may render features in a smaller field of view than the starting node-this smaller field of view may be relevant to each user rather than the group of users. The first middle rendering node may additionally only serve a smaller number of users (e.g. half of the large group of users), with the remaining users being served by a second middle rendering node which also receives the wide field of view from the starting node.

The middle rendering node(s) may then send sequences of second partially or fully rendered frames to an end device for each user. The end device may perform further processes such as warping or focal distance adjustments, optionally using depth map data.

Preferably, each rendering node encodes the partially or fully rendered frames before transmitting them on to a next rendering node or to the receiver 35. This means that the required communication resources can be reduced when the rendering nodes are separated by one or more networks, or more generally are implemented in a distributed system such as a cloud.

However, each rendering node in a chain is encoding a different partially or fully rendered frame, with different data. Therefore, it may be advantageous for different rendering nodes to use different rendering formats and/or encoding formats. For example, the output from a first rendering node may be point cloud data which logically describes a 3D scene. This point cloud data can be encoded using the techniques of EP21386059.6. A second rendering node may then operate on the point cloud data to generate image data that is more readily displayed by a generic display device, without requiring the display device to model the 3D environment. This image data may be encoded using video coding techniques.

The chaining of rendering nodes may be extended to arbitrary tree structures, where a rendering node obtains partially rendered frames from more than one preceding rendering node, and generates further partially or fully rendered frames based on the multiple obtained sequences of partially rendered frames.

For example, a content rendering network (CRN) comprising numerous rendering nodes may be used to serve a volumetric event to a large number of same-time users, such as users participating in a shared virtual environment. Rendering the same event for each user is far more expensive in terms of computation time and power consumption than rendering the volumetric effect once and performing the rendering equivalent of multicasting the volumetric effect for multiple users. For example, each user may have a second rendering node (such as a VR headset), and the network may comprise a central first rendering node. The first rendering node may render the volumetric event, and distribute partially rendered frames depicting the volumetric event to the different second rendering nodes. The second rendering node for each user may then integrate the partially rendered frames depicting the volumetric event into a view of the virtual environment which is currently being shown to each user, based on parameters such as the user's virtual position.

The receiver 35, decoder 36 and display device 37 may be consolidated into a single device, or may be separated into two or more devices. For example, some VR headset systems comprise a base unit and a headset unit which communicate with each other. The receiver 35 and decoder 36 may be incorporated into such a base unit.

In some embodiments, the network 34 may be omitted. For example, a home display system may comprise a base unit configured as an image source, and a portable display unit comprising the display device 37.

In the event that the decoder 36 or the display device 37 does not or cannot handle one or more layers, the receiver 35 or another transmitter associated with the decoder 36 or display device 37 may send a corresponding layer drop indication back through the network 34. The layer drop indication may be received by each rendering node. A rendering node which generates partially or fully rendered frames for that specific decoder 36 or display device 37 may cease generating the dropped layer. On the other hand, a rendering node which generates partially or fully rendered frames for multiple end devices may disregard a layer drop indication received from one end device (as the dropped layer is still needed for other devices). Alternatively, rendering nodes which serve multiple end devices may record received layer drop indications, and may cease generating the dropped layer only when all end devices served by the rendering node indicate that the layer is to be dropped.

In preferred examples, the encoders or decoders are part of a tier-based hierarchical coding scheme or format. Hierarchical coding enables frames to be communicated with higher resolution and/or higher frame rate than is possible in single-tier coding schemes. In hierarchical coding, one or more enhancement layers is communicated with base data, where the enhancement layers can be used to up-sample the base data at the decoder, for example providing upsampling in a spatial or temporal dimension. When combined with equivalent down-sampling of the original frames and generation of the enhancement layer at an encoder, hierarchical coding can overall provide lossless compression of data, with higher resolution and/or higher frame rate for a given transmission bit rate. Examples of a tier-based hierarchical coding scheme include LCEVC: MPEG-5 Part 2 LCEVC (“Low Complexity Enhancement Video Coding”) and VC-6: SMPTE VC-6 ST-2117, the former being described in PCT/GB2020/050695, published as WO 2020/188273, (and the associated standard document) and the latter being described in PCT/GB2018/053552, published as WO2019/111010, (and the associated standard document), all of which are incorporated by reference herein. However, the concepts illustrated herein need not be limited to these specific hierarchical coding schemes.

A further example is described in WO2018/046940, which is incorporated by reference herein. In this example, a set of residuals are encoded relative to the residuals stored in a temporal buffer.

LCEVC (Low-Complexity Enhancement Video Coding) is a standardised coding method set out in standard specification documents including the Text of ISO/IEC 23094-2 Ed 1 Low Complexity Enhancement Video Coding published in November 2021, which is incorporated by reference herein.

FIGS. 4A and 4B schematically illustrate selected features of an LCEVC encoder 402 and LCEVC decoder 404 which illustrate how LCEVC can be used to efficiently encode and decode the static image area 3. Further implementation details for these types of encoders and decoders are set out in earlier-published patent applications GB1615265.4 and WO2020188273, each of which is incorporated here by reference.

In each of the encoder 402 and the decoder 404, items are shown on two logical levels. The two levels are separated by a dashed line. Items on the first, highest level relate to data at a relatively high level of quality. Items on the second, lowest level relate to data at a relatively low level of quality. The relatively high and relatively low levels of quality relate to a tiered hierarchy having multiple levels of quality. In some examples, the tiered hierarchy comprises more than two levels of quality. In such examples, the encoder 402 and the decoder 404 may include more than two different levels. There may be one or more other levels above and/or below those depicted in FIGS. 4A and 4B.

Referring to FIG. 4A, an encoder 402 obtains input data 406 at a relatively high level of quality. The input data 406 comprises a first rendition of a first time sample, t₁, of a signal at the relatively high level of quality. The input data 406 may, for example, comprise an image generated by the image generator 31. The encoder 402 uses the input data 406 to derive downsampled data 412 at the relatively low level of quality, for example by performing a downsampling operation on the input data 406. Where the downsampled data 412 is processed at the relatively low level of quality, such processing generates processed data 413 at the relatively low level of quality.

In some examples, generating the processed data 413 involves encoding the downsampled data 412. Encoding the downsampled data 412 produces an encoded signal at the relatively low level of quality. The encoder 402 may output the encoded signal, for example for transmission to the decoder 404. Instead of being produced in the encoder 402, the encoded signal may be produced by an encoding device that is separate from the encoder 402. The encoded signal may be an H.264 encoded signal. H.264 encoding can involve arranging a sequence of images into a Group of Pictures (GOP). Each image in the GOP is representative of a different time sample of the signal. A given image in the GOP may be encoded using one or more reference images associated with earlier and/or later time samples from the same GOP, in a process known as ‘inter-frame prediction’.

Generating the processed data 413 at the relatively low level of quality may further involve decoding the encoded signal at the relatively low level of quality. The decoding operation may be performed to emulate a decoding operation at the decoder 404, as will become apparent below. Decoding the encoded signal produces a decoded signal at the relatively low level of quality. In some examples, the encoder 402 decodes the encoded signal at the relatively low level of quality to produce the decoded signal at the relatively low level of quality. In other examples, the encoder 402 receives the decoded signal at the relatively low level of quality, for example from an encoding and/or decoding device that is separate from the encoder 402. The encoded signal may be decoded using an H.264 decoder. H.264 decoding results in a sequence of images (that is, a sequence of time samples of the signal) at the relatively low level of quality. None of the individual images is indicative of a temporal correlation between different images in the sequence following the completion of the H.264 decoding process. Therefore, any exploitation of temporal correlation between sequential images that is employed by H.264 encoding is removed during H.264 decoding, as sequential images are decoupled from one another. The processing that follows is therefore performed on an image-by-image basis where the encoder 402 processes video signal data.

In an example, generating the processed data 413 at the relatively low level of quality further involves obtaining correction data based on a comparison between the downsampled data 412 and the decoded signal obtained by the encoder 402, for example based on the difference between the downsampled data 412 and the decoded signal. The correction data can be used to correct for errors introduced in encoding and decoding the downsampled data 412. In some examples, the encoder 402 outputs the correction data, for example for transmission to the decoder 404, as well as the encoded signal. This allows the recipient to correct for the errors introduced in encoding and decoding the downsampled data 412.

In some examples, generating the processed data 413 at the relatively low level of quality further involves correcting the decoded signal using the correction data. In other examples, rather than correcting the decoded signal using the correction data, the encoder 402 uses the downsampled data 412.

In some examples, generating the processed data 413 involves performing one or more operations other than the encoding, decoding, obtaining and correcting acts described above.

However, in some examples no processing is performed on the downsampled data 412.

Data at the relatively low level of quality is used to derive upsampled data 414 at the relatively high level of quality, for example by performing an upsampling operation on the data at the relatively low level of quality. The upsampled data 414 comprises a second rendition of the first time sample of the signal at the relatively high level of quality. The encoder 402 obtains a set of residual elements 416 useable to reconstruct the input data 406 using the upsampled data 414. The set of residual elements 416 is associated with the first time sample, t₁, of the signal. The set of residual elements 416 is obtained by comparing the input data 406 with the upsampled data 414.

In this example, the encoder 402 generates a set of temporal correlation elements 426. The term “temporal correlation element” is used herein to mean a correlation element that indicates an extent of temporal correlation. The temporal correlation element may further be a spatio-temporal correlation element indicating an extent of spatial correlation between residual elements. In this example, the set of temporal correlation elements 426 is associated with both the first time sample, t₁, of the signal, and a second time sample, t₀, of the signal. In the examples described herein, the second time sample, t₀, is an earlier time sample relative to the first time sample. In other examples, however, the second time sample, t₀, is a later time sample relative to the first time sample, t₁. In some examples, where the input data 406 comprises a sequence of time samples, an earlier time sample means a time sample that precedes the first time sample, t₁, in the input data. Where the first time sample, t₁, and the earlier time sample are arranged in presentation order, the earlier time sample precedes the first time sample, t₁.

The second time sample, t₀, may be an immediately preceding time sample in relation to the first time sample, t₁. In some examples, the second time sample, t₀, is a preceding time sample relative to the first time sample, t₁, but not an immediately preceding time sample relative to the first time sample, t₁.

In this example, the set of temporal correlation elements 426 is indicative of an extent of spatial correlation between a plurality of residual elements in the set of residual elements 416. The set of temporal correlation elements 426 is also indicative of an extent of temporal correlation between first reference data based on the input data 406 and second reference data based on a rendition of the second time sample, t₀, of the signal, for example at the relatively high level of quality. The first reference data is therefore associated with the first time sample, t₁, of the signal, and the second reference data is associated with the second time sample, t₀, of the signal. The first reference data and the second reference data are used as references or comparators for determining an extent of temporal correlation in relation to the first time sample, t₁, of the signal and the second time sample, t₂, of the signal. The first reference data and/or the second reference data may be at the relatively high level of quality.

In some examples, the first reference data and the second reference data comprise first and second sets of spatial correlation elements, respectively, the first set of spatial correlation elements being associated with the first time sample, t₁, of the signal, and the second set of spatial correlation elements being associated with the second time sample, t₀, of the signal.

In other examples, the first reference data and the second reference data comprise first and second renditions of the signal, respectively, the first rendition being associated with the first time sample, t₁, of the signal, and the second rendition being associated with the second time sample, t₀, of the signal.

The set of temporal correlation elements 426 will be referred to hereinafter as “At correlation elements”, since temporal correlation is exploited using data from a different time sample to generate the Δₜ correlation elements 426.

In this example, the encoder 402 transmits the set of Δₜ correlation elements 426 instead. Since the set of Δₜ correlation elements 426 exploit temporal redundancy at the higher, residual level, the set of Δₜ correlation elements 426 are likely to be small where there is a strong temporal correlation, and may comprise more correlation elements with zero values in some cases. Less data may therefore be used to transmit the set of Δₜ correlation elements 426 when applied to the static image area 3 (which is static, and only changes internally) when compared to the warpable images 2a, 2b, 2c (the boundaries of which can change for each frame).

Turning now to FIG. 4B, the decoder 404 receives data 420 based on the downsampled data 412 and receives the set of Δₜ correlation elements 426.

Where the encoder 402 has processed the downsampled data 412 to generate processed data 413, the decoder 404 processes the received data 420 to generate processed data 422. The processing may comprise decoding an encoded signal to produce a decoded signal at the relatively low level of quality. In some examples, the decoder 404 does not perform such processing on the received data 420. Data at the relatively low level of quality, for example the received data 420 or the processed data 422, is used to derive the upsampled data 414. The upsampled data 414 may be derived by performing an upsampling operation on the data at the relatively low level of quality.

The decoder 404 obtains the set of residual elements 416 based at least in part on the set of Δₜ correlation elements 426. The set of residual elements 416 is useable to reconstruct the input data 406 using the upsampled data 414.

This disclosure describes an implementation for integration of a hybrid backward-compatible coding technology with existing decoders, optionally via a software update. In a non-limiting example, the disclosure relates to an implementation and integration of MPEG-5 Part 2 Low Complexity Enhancement Video Coding (LCEVC). LCEVC is a hybrid backward-compatible coding technology which is a flexible, adaptable, highly efficient and computationally inexpensive coding format combining a different video coding format, a base codec (i.e. an encoder-decoder pair such as AVC/H.264, HEVC/H.265, or any other present or future codec, as well as non-standard algorithms such as VP9, AV1 and others) with one or more enhancement levels of coded data.

Example hybrid backward-compatible coding technologies use a down-sampled source signal encoded using a base codec to form a base stream. An enhancement stream is formed using an encoded set of residuals which correct or enhance the base stream for example by increasing resolution or by increasing frame rate. There may be multiple levels of enhancement data in a hierarchical structure. In certain arrangements, the base stream may be decoded by a hardware decoder while the enhancement stream may be suitable for being processed using a software implementation. Thus, streams are considered to be a base stream and one or more enhancement streams, where there are typically two enhancement streams possible but often one enhancement stream used. It is worth noting that typically the base stream may be decodable by a hardware decoder while the enhancement stream(s) may be suitable for software processing implementation with suitable power consumption. Streams can also be considered as layers.

The combined intermediate picture is then upsampled again to give a preliminary output picture at a highest resolution. A second enhancement sub-layer is combined with the preliminary output picture to give a combined output picture.

The second enhancement sub-layer may be partly derived from a temporal buffer, which is a store of the second enhancement sub-layer used for a previous frame. The use of a temporal buffer reduces the amount of data needs to be included as part of the encoded frame. A temporal buffer may equally be used for the first enhancement sub-layer.

An indication of whether the temporal buffer can be used for the current frame, or which parts of the temporal buffer can be used for the current frame, may be included with the encoded frame. Alternatively, the decoder may itself determine that the temporal buffer cannot be used for the current frame, such as in the case that the first or second enhancement sub-layer was dropped or incorrectly received for the previous frame and therefore the temporal buffer is out-of-date.

Similarly, an indication of whether the temporal buffer should be used for the current frame may be sent to the encoder before it is encoded. For example, the decoder may send an enhancement layer (or sub-layer) drop indication after the decoder fails to receive the first or second enhancement sub-layer for a previous frame. If the encoder receives a drop indication, the encoder may transmit the set of residual elements 416 rather than the set of At correlation elements 426 for the current frame.

The video frame is encoded hierarchically as opposed to using block-based approaches as done in the MPEG family of algorithms. Hierarchically encoding a frame includes generating residuals for the full frame, and then a reduced or decimated frame and so on. In the examples described herein, residuals may be considered to be errors or differences at a particular level of quality or resolution.

For context purposes only, as the detailed structure of LCEVC is known and set out in the approved draft standards specification, FIG. 4B illustrates, in a logical flow, how LCEVC operates on the decoding side assuming H.264 as the base codec. Those skilled in the art will understand how the examples described herein are also applicable to other multi-layer coding schemes (e.g., those that use a base layer and an enhancement layer) based on the general description of LCEVC The LCEVC decoder works at individual video frame level. It takes as an input a decoded low-resolution picture from a base (H.264 or other) video decoder and the LCEVC enhancement data to produce a decoded full-resolution picture ready for rendering on the display view. The LCEVC enhancement data is typically received either in Supplemental Enhancement Information (SEI) of the H.264 Network Abstraction Layer (NAL), or in an additional data Packet Identifier (PID) and is separated from the base encoded video by a demultiplexer. Hence, the base video decoder receives a demultiplexed encoded base stream and the LCEVC decoder receives a demultiplexed encoded enhancement stream, which is decoded by the LCEVC decoder to generate a set of residuals for combination with the decoded low-resolution picture from the base video decoder.

LCEVC can be rapidly implemented in existing decoders with a software update and is inherently backwards-compatible since devices that have not yet been updated to decode LCEVC are able to play the video using the underlying base codec, which further simplifies deployment.

In this context, there is proposed herein a decoder implementation to integrate decoding and rendering with existing systems and devices that perform base decoding. The integration is easy to deploy. It also enables the support of a broad range of encoding and player vendors, and can be updated easily to support future systems. Embodiments of the invention specifically relate to how to implement LCEVC in such a way as to provide for decoding of protected content in a secure manner.

The proposed decoder implementation may be provided through an optimised software library for decoding MPEG-5 LCEVC enhanced streams, providing a simple yet powerful control interface or API. This allows developers flexibility and the ability to deploy LCEVC at any level of a software stack, e.g. from low-level command-line tools to integrations with commonly used open-source encoders and players. In particular, embodiments of the present invention generally relate to a driver-level implementations and a System on a chip (SoC) level implementation.

The terms LCEVC and enhancement may be used herein interchangeably, for example, the enhancement layer may comprise one or more enhancement streams, that is, the residuals data of the LCEVC enhancement data.

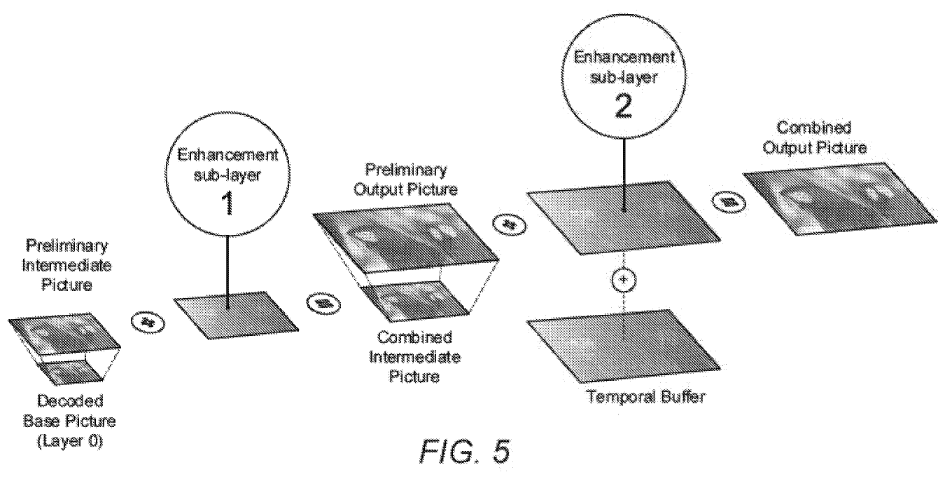

FIG. 5 is a schematic diagram showing process flow of LCEVC. At a first step, a base decoder decodes a base layer to obtain low resolution frames (i.e. the base layer). As a next step, an initial enhancement (a sub layer of the enhancement layer) corrects artifacts in the base. As a further step, final frames (for output) are reconstructed at the target resolution by a applying further (e.g. further residual details) sub layer of the enhancement layer. This illustrates that by best exploiting the characteristics of existing codecs and the enhancement, LCEVC improves quality and reduces the overall computational requirements of encoding. Embodiments of the invention provide for this to be achieved in a secure manner (e.g. when handling protected content).

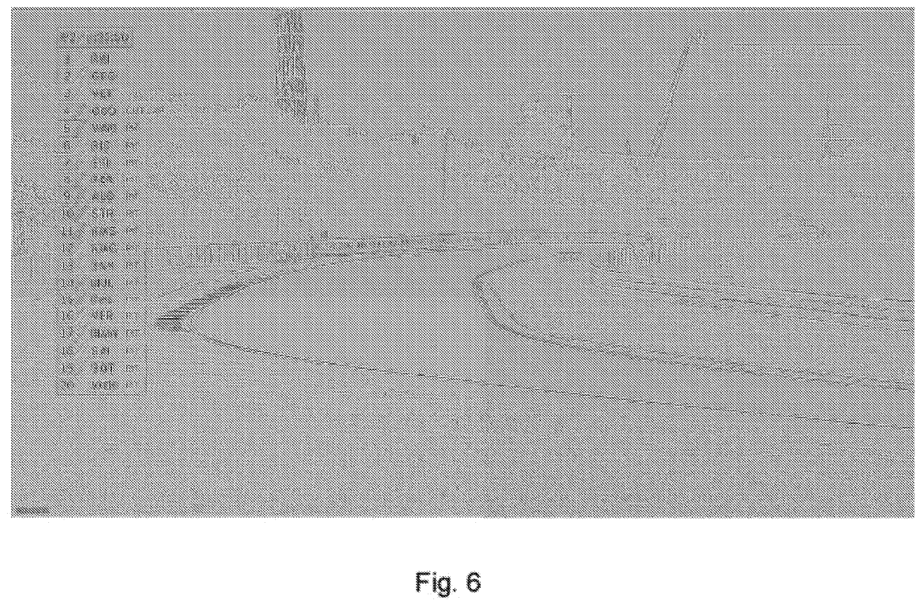

FIG. 6 illustrates an enhancement layer. As can be seen, the enhancement layer comprises sparse highly detailed information, which are not interesting (or valuable to a viewer) without the base video. However, subtle movements in the rendered XR view would increase the information stored in this enhancement layer.

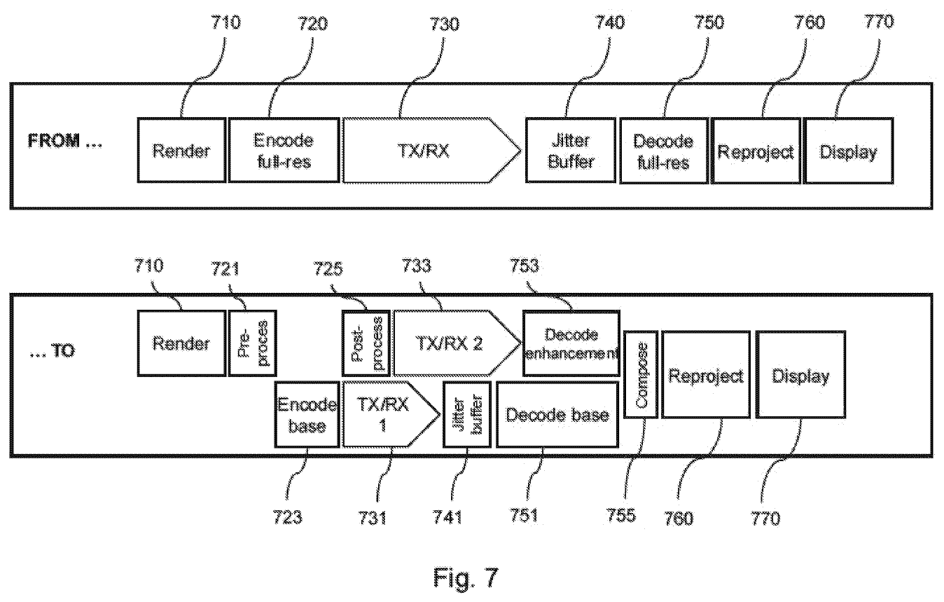

FIG. 7 illustrates a comparison between the latency when using a hierarchical coding scheme (such as LCEVC) and when using a fully-serial coding scheme within a VR or XR pipeline.

As shown in FIG. 7, both methods begin with rendering 710 at a source device. This may be any process of generating frame data, such as image data or point cloud data, as discussed above.

In the fully-serial scheme, each frame is then encoded at full-resolution 720. This may be implemented using any standard codec such that is suitable for the frame data, such as h.264, HEVC, AV1 or VVC for video data (which are generally single layer codecs).

Then, at step 730, the encoded frame is transmitted from the source device to a destination device. For example, the encoded frames may be transmitted between nodes of a content rendering network, or between a server and a user device.

At step 740, the encoded frame is received and stored in a jitter buffer until the receiving entity is ready to process the frame.

At step 750, the receiving entity decodes the full-resolution frame.

The fully-serial scheme ends with reprojection 760 and display 770 of the frame data. Reprojection may include warping as discussed above.

The hierarchical coding scheme differs in that, after rendering 710, each frame is pre-processed 721 to produce a base layer. This typically involves down-sampling such as a reduction in spatial resolution for image data.

Then at step 723, the base layer is encoded using a base codec. This may be implemented using any standard codec such that is suitable for the frame data, such as h.264, HEVC, AV1 or VVC for video data (which are generally single layer codecs). Alternatively, the base codec may itself be a hierarchical codec. The base codec may be lossy, such that encoding and then decoding the base layer does not exactly recover the original data of the base layer.

Finally, at step 725, the encoder uses data from the encoded base layer in order to generate at least one enhancement layer. This typically involves a comparison between the original frame generated by the rendering 710 and a decoding of the encoded base layer generated at step 723. For example, this may be implemented using the LCEVC techniques described with respect to FIG. 4A. Step 725 may also comprise performing an encoding method on the enhancement layer to produce an encoded enhancement layer. This may include inter-frame encoding of a difference between the enhancement layer of the current frame and the enhancement layer of a preceding frame. Additionally or alternatively, generic encoding methods for data transmission, such as addition of check bits, may be performed.

The hierarchical coding scheme also differs from the serial coding scheme in that transmission and decoding can be split into two parallel processes or streams.

A first parallel process begins at step 731, when the encoded base layer is transmitted. This can begin as soon as the base layer is encoded at step 723. The receiving entity stores the encoded base layer of each frame in a jitter buffer 741, until it is ready to decode the base layer at step 751. The jitter buffer 741 can be smaller than the jitter buffer 740 because the base layer is a down-sampled version of the frame stored in jitter buffer 740 of the serial coding scheme. The encoded frame(s) in the jitter buffer 741 thus take up less space than the full-resolution frame(s) in jitter buffer 740 and take less time (and/or fewer computing resources) to decode than the full-resolution frame(s) in jitter buffer 740.

A second parallel process begins at step 733, when the enhancement layer(s) are transmitted. This can begin after the enhancement layer(s) are generated and/or encoded at step 725. When an encoded enhancement layer is received at the destination device, it is decoded 753 to recover the enhancement layer.

The first and second parallel processes then merge at a composition step 755. In composition, the base layer and enhancement layer are combined to produce a reconstructed rendition of the original frame as rendered in step 710. In the case of a lossless hierarchical codec, the reconstructed rendition is equivalent to the original frame, and in the case of a lossy hierarchical codec, the reconstructed rendition should at least have similar characteristics to the original frame in terms of resolution etc. For example, composition may involve upsampling the base layer and using values from the enhancement layer to correct compression losses in the upsampled base layer caused by the base codec. The upsampling of the base layer may instead be incorporated at the end of the second parallel process, prior to the composition step 755.

The hierarchical scheme ends with reprojection 760 and display 770 of the frame data. These steps are the same as for the fully-serial scheme.

In the fully-serial scheme, frames are encoded and decoded at a full-resolution, which takes longer than encoding and decoding at a lower base resolution. Additionally, jitter buffering takes longer or takes more processing resources, and requires more space at the full resolution than at the lower base resolution.

On the other hand, the hierarchical coding scheme requires additional processes including pre-processing and post-analysis (generating the enhancement layer(s)) at the encoder, and decoding of the enhancement layer and composing of the decoded layers at the decoder. Nevertheless, the additional complexity of hierarchical coding is outweighed by the time/resources saved by encoding and decoding at a lower base resolution. As a result, the overall latency is lower for hierarchical coding than for full-resolution coding, especially when processing of the enhancement layer and base layer is performed in parallel as far as possible.

Hierarchical coding also provides new degrees of freedom when coding and transmitting data. Enhancement data can be dropped in the case of sudden bandwidth drops, reducing latency jitter. Additionally, latency gains can be obtained by using particular constructs found in hierarchical coding (such as the LCEVC standard) including tiles and stripes. More specifically, the base layer encoding of a frame area can be decoded in a series of parallel stripes. In implementations such as LCEVC, only one stripe is needed for calculating the enhancement layer, and therefore calculation of the enhancement layer can begin as soon as one stripe of the base layer has been decoded by the encoder. Similarly, the base layer can be transmitted as individual encoded stripes rather than complete encoded frames, which enables an earlier start to transmission of the base layer of a frame. Furthermore, enhancement layers enable higher bit-depth encoding. For example LCEVC supports 14-bit depth maps and HDR, even if the base encoder only supports 8-bit or 10-bit base layers

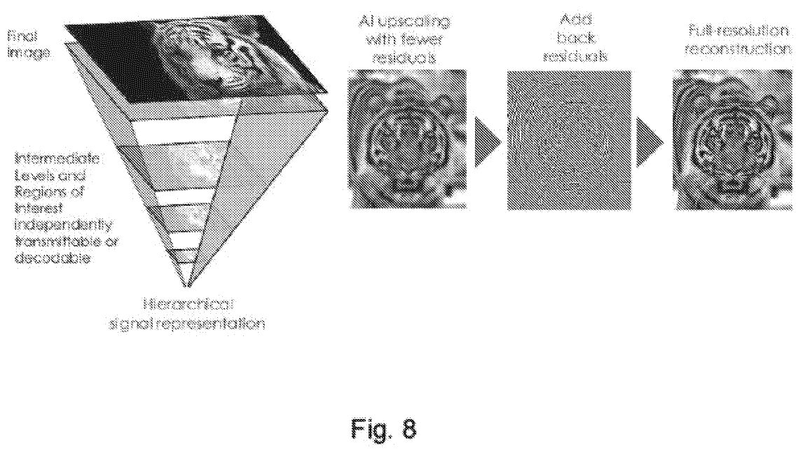

FIG. 8 schematically illustrates VC-6 coding, which has been described in more detail in the standard document VC-6: SMPTE VC-6 ST-2117, as well as WO 2019/111010, all of which are incorporated by reference herein. Similarly to LCEVC coding, VC-6 uses downsampling to transmit an encoded base layer at reduced resolution, and the original data is recovered at the decoder using one or more enhancement layers.

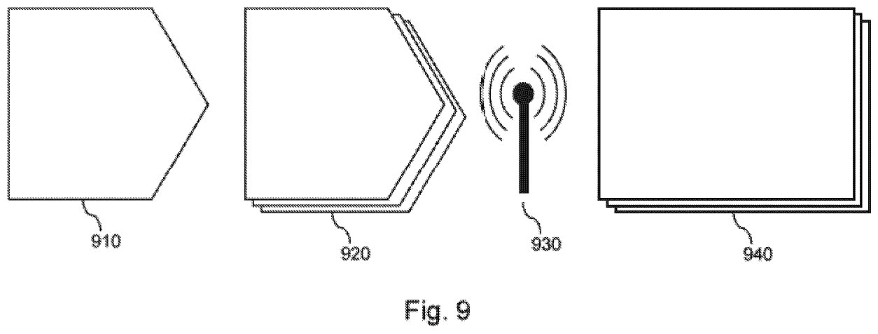

FIG. 9 schematically illustrates an example networked system for distributed rendering, which may be called a “content rendering network”.

A first CRN node 910 performs first-pass volumetric rendering of a relevant zone-of-view in a virtual environment. This rendering is performed once for multiple viewing devices, and includes the most computationally-expensive parts of the rendering such as ray tracing. This rendering may be performed at a relatively low frame rate (such as 25 fps) and may include motion information for upsampling at a downstream node in the network.

The frames rendered by the first CRN node 910 are transmitted to an edge CRN node 920, which is closer to a specific user or a specific group of users. If there are multiple users or multiple groups of users, the frames rendered by the first CRN node 910 may be transmitted to multiple edge CRN nodes 920 each associated with a respective user or users.

Each edge CRN node 920 performs second-pass rendering of a user view-port (i.e. the area of the virtual environment visible to a specific user) and encodes frames having one or more of an image layer and a depth map layer, for display of a 3D environment as discussed above. This rendering may be performed once per user group, for example if the data is in an MPEG immersive video (MIV) format, defined in ISO/IEC FDIS 23090-12 which is incorporated herein by reference. Alternatively, if the data is in another video format, the rendering may be performed once per user. This rendering may be performed at a higher frame rate (such as 50 fps), using interpolation based on the motion information generated by the first CRN node 910.

The frames rendered by the edge CRN node 920 are then streamed to a user device 940 via a network 930. The network 930 may have an air interface, such as between a user headset and a user base unit.

The user device 940 performs low-complexity decoding at a display resolution and a display frame rate. Space-warping reprojection may be applied at this stage, using the depth map layer.

Even when the network speed is as low as 30 Mbps, the inventors have found that the above described coding techniques can support streaming which is resilient to packet loss and which can compensate for any network limitations by dropping layers, such that acceptable VR streaming is guaranteed as far as possible, and higher definition streaming is provided where this is supported by the network and the user device.

The following forms part of the description.

### XR and the Metaverse: How to Achieve Interoperability, Wow Factor and Mass Adoption

Weed off the inevitable hype and make no mistake: in some form or fashion, the Metaverse and Extended Reality (XR) are here to stay and become the next-generation Internet. It pays off to understand them better, along with the corresponding requirements and technical implications.

However, despite affordable XR devices becoming fit for purpose, a remaining bottleneck to overcome is the huge volume of data often required to enable immersive XR experiences at suitable quality, for instance via “split computing” or “cloud rendering.

“In this application, “split computing” is the process of dividing computation into two or more devices, with 3D rendering performed on a device (nearby or remote) different from the display device. Rendering may also be further split across multiple resources (“hybrid rendering”). The resulting rendered frames are then streamed (“cast”) to the display device.

The inventors have considered several technical challenges, related to what happens before 3D rendering and after 3D rendering:
The three key user requirements for mass-market adoption: lighter devices, interoperability, no compromise on quality.
Moore's Law and Koomey's Law cannot bridge the graphics processing power gap of XR devices vs. gaming hardware. Consequently, the inventors have identified high-quality interoperable XR applications may instead operate via split computing and ultra-low-latency video casting.
The data compression challenges of delivering volumetric objects to rendering devices and then casting high-quality ultra-low-latency video to XR displays will require low-complexity multi-layer data coding methods, which can make efficient use of available resources and are particularly well-suited to 3D rendering engines.
Two recently standardized low-complexity multi-layer codecs-MPEG-5 LCEVC and SMPTE VC-6-have what it takes to enable high-quality Metaverse/XR applications within realistic constraints. LCEVC enhances any video codec (e.g., h.264, HEVC, AV1, VVC) to enable ultra-low-latency delivery high-quality XR video (or even video+depth) within strict wireless constraints (<30 Mbps), while also reducing latency jitter thanks to the possibility to drop top-layer packets on the fly in case of sudden drops of network bandwidth. Application of the VC-6 toolkit to point cloud compression enabled mass distribution of photorealistic 6DoF volumetric video at never-seen-before qualities, with excellent feedback from both end users and Hollywood Studios.
XR rendering and video casting are 1:1 operations in many scenarios, with content being rendered for individual users. As a result, power usage may grow linearly with users, differently from broadcasting and video streaming. In that context, sustainability and energy consumption are important considerations, strengthening the case for low-complexity multi-layered coding.
The ability to suitably tackle the data volume challenges, promptly leveraging on the approaches and standards that are available, will be one of the key factors driving the speed with which the XR meta-universe is brought to the masses.

### What Exactly is the Metaverse?

The Metaverse promises to (further) break down geographical barriers by providing new virtual degrees of freedom for work, play, travel, and social interactions. But what is it, in practice, and why now?

John Riccitiello, CEO of Unity, gave a sensible definition of Metaverse (for “meta-universe”): “it is the next generation of the Internet, always real time, mostly 3D, mostly interactive, mostly social and mostly persistent”. In practice, it's a new type of Internet user interface to interact with other parties and access data as a seamless and intuitive augmentation with the actual world in front of us, inspired by the online 3D worlds already familiar to users of multiplayer video games. Metaverse solutions often aim to replicate the 6 Degrees of Freedom (6DoF) and inherent depth witnessed in the real world, as opposed to the flat 2D interfaces we use to browse online. Often mentioned interchangeably with the term “extended Reality” (XR, combination of Virtual Reality and Augmented Reality), the Metaverse promises to be the largest step-change in the evolution of networked computing since the introduction of the World Wide Web back in the 1990s, when we went from relatively exoteric text-based interfaces to intuitive “browsing” of hypertexts with multimedia components.

This new paradigm (Metaverse, Cyberspace, 6DoF 3D) is different and powerful in the way that it will replicate the inherent depth and intuitiveness of the real world, as opposed to the flat hypertextual interfaces that we use today.

### Why Now?

Gamers have been playing for decades within 3D worlds with 6 Degrees of Freedom (6DoF), so one may rightfully ask how come we haven't already been e-shopping in 3D and/or working on Excel spreadsheets in 6DoF 3D for the past twenty years? If GTA V was able to make us free to roam around a pretty good proxy of Southern California, how come Microsoft Office, Amazon, Instagram and SAP are all still so boringly flat?

In fact, transitioning non-gaming applications to 6DoF 3D has been hindered so far by a few technical barriers, which are now close to being surpassed.

Undoubtedly, an obvious barrier to immersive XR was so far represented by clunky VR headsets that could not meet the resolutions and frame rates necessary for a smooth experience. Someone may still remember trying a Virtuality headset in the early Nineties and feeling motion sick. Others may remember comments on form factors being uncool, or fears of “isolating” VR users in their digital worlds. Commercially available headsets are now much lighter, allow for non-isolated Augmented Reality and finally work well enough from a visual standpoint, to the point that average consumers may find them appealing. Upcoming headsets soon to be released will further address some of the remaining pain-points for realism, such as projecting an image of the user's face to reduce the sense of “physical separation” for people outside the headset, adding sensors for real-time eye-tracking and face-tracking for more realistic social interactions in the Metaverse, and including varifocal display technology to address the focus problem-which is technically called the “vergence-accomodation disconnect”, i.e., displays forcing you to focus about 1.5 m away regardless of depth. All in all, we are rapidly getting to headsets that are good-enough for mass adoption.

However, suboptimal headsets were not the only barrier to the rise of the Metaverse. 6DoF 3D digital worlds do not necessarily require immersive XR, as demonstrated by 3D video games happily thriving on traditional flat screens for decades. Why haven't we seen office productivity tools, e-commerce websites or other software applications following the steps of video games?

The other big barrier to non-gaming use of 3D worlds was so far the difficulty of integrating intuitive 6DoF controls with the peripheral input devices that we normally use on our laptops, tablets and mobiles.

Keyboards, mice, touch pads and touch screens are great, but none of them are particularly suited to 6DoF navigation of 3D environments. Excluding game controllers, the holy grail for taming intuitive 6DoF controls finally became mature in the latest handful of years: gesture controls driven by inexpensive cameras and Infra-Red proximity sensors are now found in many devices.

This type of immersive interface will not be limited to XR displays that we wear on our face. Even traditional flat-screen devices such as laptops, mobiles and large screens are being equipped with cameras and IR sensors capable of gesture detection and head tracking. Already today, for just a few thousand dollars one can buy a glasses-free auto-stereoscopic 8K screen that tracks head and eye movements so as to show a volumetric scene that we can look at as if it was coming out of the screen, with the screen effectively behaving like a window to a 6DoF 3D digital world.

Depending on the application, immersive 3D interfaces with integrated gesture control will come through evolution as much as revolution, similarly to what we have seen in previous decades with hypertexts and touch screen interfaces. Hypertexts and traditional (“rectilinear”) video feeds will also continue to exist in the Metaverse: they will just be displayed in the context of an immersive user interface and manipulated intuitively in 6DoF.

### Actually, Why Not Yet?

There is demand for more intuitive and immersive digital applications, and everything described is already technically feasible today with relatively inexpensive devices. Many people have started buying those devices: there will soon be over 20 million households equipped with at least one of the latest-gen headsets. Lighter AR glasses are already capable of doing augmented reality as described above, with a new and improved generation expected soon, spurred by other Big Tech heavyweights entering the arena. Some glass-free autostereoscopic displays are close to the cost of traditional displays. Pretty much any flat-screen device is being equipped with cameras and IR sensors capable of gesture tracking and head tracking.

If there is consumer demand for more intuitive and immersive digital applications, and all the technology just described is commercially available today and affordable, why aren't we all on the Metaverse already? What are the remaining barriers?

### Key User Requirements for Mass Marketiung Adoption

In adoption-cycle terminology, XR consumers have gone from innovators (pre-2020) to early adopters (2020-2022), and new compelling XR experiences are emerging every day. Is it all working well enough and seamlessly enough to also entice the proverbial “early majority” (which inevitably incorporates non-gaming use cases)?

Mass adoption requires us to address three key user requirements:
XR devices must be small and light, ideally as light as a pair of eye-glasses and with a maximum peak power consumption of 1-2 Watts. That leaves room for very little electronics and battery, which are not suitable to crunch high-quality 3D rendering in real time. Small form-factors are a prerequisite to scale, since people cannot “wear a gaming laptop on their face” (or even a powerful mobile phone) for several hours a day.
Metaverse applications must be as interoperable as web pages, meaning that very different viewing devices (including both XR headsets/smart-glasses and more traditional TVs, mobile phones, tablets or laptops) with very diverse computational capacities must be able to access them. Interoperability is obviously important to service providers, to ensure the greatest possible user base for their services.
Quality of experience is non-negotiable: end-users expect visually stunning, realistic, smooth and immersive experiences. This is of little surprise when video gamers now take for granted that the average football game allows them to see the beads of sweat dripping from the brow of their virtual footballers. While traditional 2D user interfaces may tolerate some imperfections, the point of the Metaverse is precisely the illusion of “presence”, which by necessity requires top-notch audio-visual quality, high quality 3D objects, realistic lighting, high resolutions, high frame rates and low-latency real time. Sketchy objects and sluggish frame rates will not suffice and may even make users feel (motion) sick. Unsurprisingly, the previously mentioned Mckinsey analysis demonstrated high correlation between realism of the experience and frequency of use, pushing companies to build more realistic experiences.

After identifying the above requirements, the inventors have identified that the first two requirements call for seamless “split computing”, meaning that most computations—and especially 3D rendering—must be performed on another device, possibly even in the cloud, so that when needed you can time-share more powerful GPUs than you would otherwise be able to equip with. The resulting rendered graphics frames must be streamed to the device as high-resolution high-framerate ultra-low-latency stereoscopic video. As we will see in the next section, the constraints associated to XR casting are pretty much the worst possible nightmare for video coding, especially when wireless connectivity (wi-fi or 5G) is involved. Luckily, we will also see that there is a standard solution that makes it possible within realistic constraints.

Aside from enabling sophisticated graphics to be displayed on low-power display devices, computing remotely and then streaming video to the display device is the best way to guarantee interoperability of Metaverse destinations, the second key requirement. Regardless of the available computing capacity, any device is able to connect to a remote server and receive a video stream, including mobiles, TVs, autostereoscopic displays, XR headsets and XR smart-glasses. The server can also seamlessly handle the difference in quality that each device can display, adapting the format and quality of the video stream according to the specific user device and network conditions: in a sense, video can act as the new HTML, with metadata, enhancement layers and ancillary data channels acting similarly to hypertext objects enriching the baseline webpage.

The third requirement implies the dawn of many new types of large data sets on top of traditional audio, images and video (90+% of current Internet traffic) that will need to be efficiently exchanged within the metaverse. Examples will include immersive audio, point clouds of various natures, meshes, textures, stereoscopic video, video +depth maps for reprojections, etc. The critical difference between Metaverse destinations and video games is that volumetric objects may be more difficult to pre-load and will have to rely on real-time access: much more frequently than for gaming, we will have to stream those big 3D assets, in real time.

### Separating Rendering from Display

Accessing the Metaverse will NOT exclusively require uber-immersive XR headsets. XR will bring together headsets (over 23 million by 2023 according to IDC), lighter XR viewers the size of eye-glasses and glass-free auto-stereoscopic displays with the billions of more conventional mobile phones, tablets, PCs and TVs. Traditional flat screens will display virtual destinations similarly to what is done today with 3D games.

There is a catch. To experience realistic 3D graphics, hard-core gamers equip themselves with enough graphics horsepower (read “latest-gen discrete GPU with active cooling”), while the typical mass-market XR user may just have a headset, equipped with 50x less graphics power than the typical gaming PC, and a work laptop with iGPU, equipped with similarly underwhelming graphics power.

Said differently, since users will not accept “wearing a Playstation 5 on their face” and we can't assume that everyone is willing to buy a gaming PC, it is savvy to design Metaverse experiences to the minimum common denominator in compute and power.

That minimum common denominator-lightweight XR devices consuming 1Watt -will not be anywhere near capable of performing real-time decoding of photorealistic volumetric objects AND high-framerate 3D rendering at stereoscopic 4K resolution. The laws of physics and silicon technology don't leave space for hope: latest-gen gaming GPUs are bulky and use between 150 and 300 Watts of power to perform those tasks. Consider that your average mobile phone starts heating up when it consumes more than 4 Watts. Add the weight of cooling fans and batteries, and you get why I joked about: wearing a PS5 on our face. You're then left with mobile GPUs that can't match the level of rendering quality that end users are expecting: you can render a simple game like Beat Saber, but you can't possibly immerse a user in a photorealistic 6DoF experience. Plus, headsets with the power of a tier-1 mobile phone are still too bulky for average users to accept wearing them multiple hours per day.

Lightweight devices have a >50× graphics power gap vs the visual quality that hard-core gamers are used to experiencing.

Most modern mobile SoCs use 5 nanometer silicon technology in terms of transistor size, with long-term R&D suggesting that 2 nanometers may be the physical limit of silicon. One nanometer means about 10 electrons, so we're getting to the scale where the quantum nature of electrons makes them jump silicon gates regardless of applied voltage. In addition, while miniaturizing transistors further from 5 nm to 2 nm, transistor density will increase, but power drain per transistor is unlikely to decrease much further due to quantum tunnelling. We have already seen that with the transition from 7 nm to 5 nm, which according to TSMC increased transistor density by 80%, but improved computational performance per Watt by a mere 15%. This effect is also known as Koomey's Law, after Stanford professor Jonathan Koomey.

Differently from Moore's Law, which tracks the evolution of peak computing performance, Koomey's Law tracks the evolution of computing performance per Watt. Sadly, Koomey's Law measured a stark decrease in our ability to perform more computations for a same unit of power: from the 100× improvement per decade of the 1970's (doubling every 18 months), in the first two decades of the 21st century we have achieved ca. 15× per decade (doubling every 2.6 years), and now—for the above quantum physics reasons—we are plateauing even further.

As a result of this plateauing, it seems unlikely that a 50× processing power efficiency gain will be achieved in the next decade (and possibly never).

Processing power disparities are also relevant to interoperability, key user requirement number two. If we want Metaverse applications that are indeed “the new Web”, we must make sure that any XR device can suitably play them, with seamless interoperability. How can we efficiently cope with end user devices that may quite literally have orders of magnitude of difference in available graphics rendering power? With further silicon technology improvements acting as a placebo, the solution inventors' idea is based on the mainframe and client-server archetypes. In the 1980s, a single mainframe computer was able to control real-time user interfaces for tens or even hundreds of user terminals. This concept could be adapted to enable immersive digital worlds with seamless interoperability: for simple tasks the mainframe may be the mobile phones that you carry in your pockets, while as soon as you require serious rendering power you may seamlessly tap into the GPU resources of your nearest available shared computing node.

Performing rendering outside of the XR device also means streaming volumetric objects to the rendering device, which is more likely to be well connected to the Internet, especially if in a data center. The XR device (wirelessly connected to the Internet via Wi-fi or 5G, often <50 Mbps due to distance from the repeater, obstacles, concurrency, and packet loss from interferences) will just require enough connectivity to handle a video stream.

It's inevitable that for 3D-graphics-hungry Metaverse applications, rendering and display must be separated. A rendering device able to both crank and dissipate enough power—whether a handheld device, a nearby PC, or some powerful server somewhere “in the cloud”—will receive the compressed virtual objects, decode them, run the application and render the viewport, i.e., what the end user is watching at any one time. Even rendering itself may actually be separated across separate stages on different machines. For instance, a more powerful GPU could compute lighting information—possibly even using costly algorithms like ray tracing or path tracing, requiring >1,000× more computing power than typical game-engine lighting—, while a less powerful nearby GPU may compute the final rendering. In other cases, for complex 3D scenes with many users, costly lighting calculations may be “pooled” for multiple users, generating intermediate volumetric data that is then transmitted to multiple local edge nodes that render the final viewport for each single user. Rendering servers may be thus organized in a dynamic hierarchy, similarly to the way in which caching servers of Content Delivery Networks enable Web content delivery at scale: Such Metaverse infrastructures can be called “Content Rendering Networks” (CRNs). The resulting rendered viewport will then be cast via ultra-low-latency video streaming to the lightweight XR display device. As such, the XR device will just have to manage its sensors, process/send data of what the user is doing and decode the received high-framerate high-resolution video.

That is indeed doable at photorealistic quality within 1 Watt, especially by using a low-complexity video compression method to fit within bandwidth and processing constraints.

### The Split Computing Challeges to Make XR Feasible at Scale

The importance of suitably handling huge volumes of data can't be understated when it comes to large-scale adoption of XR. Data compression and manipulation that fits the quality, bandwidth, processing, and latency constraints of solid latest-generation network connectivity is the name of the Metaverse game, with three main technical challenges addressed by the inventors:
1. Suitable compression and streaming of volumetric objects to the rendering device as well as across rendering devices, requiring new coding approaches.
   Efficient compression/decompression of 3D objects may be undertaken with suitable lossy coding technologies to increase the chance that point clouds, textures and meshes can be effectively streamed. For hybrid rendering use cases, intermediate byproducts are preferably efficiently transmitted across different nodes of a Content Rendering Network. Previously, monolithic once-in-a-while gaming-world downloads have mostly been losslessly coded. Flexible software-based layered coding methods suitable for efficient massively parallel execution will be advantageous.
2. Ultra-low-latency video encoding at 4K 72 fps and beyond, but also at a bandwidth lower than 30-50 Mbps to cope with realistic Wi-Fi/5G sustained rates.
   For the experience not to be “wobbly”, video casting latency is desirably low and consistent. Some latency can be managed by rendering the viewport according to a forecast of where the user will be watching after the estimated system lag and then performing a last-millisecond reprojection according to where the user is effectively watching. But we are still talking about 20-30 milliseconds, with tight processing constraints. At those ultra-low-latencies, many of the latest video compression efficiency tools cannot be used, which inflates the bandwidth required to transmit a given quality. At the same time, wireless delivery means strict bandwidth constraints (<50 Mbps) before packet loss starts generating unsustainable latency jitter. Aside from choosing a suitable protocol (if possible, with some degree of forward error correction), it is particularly useful to pair up the most efficient video codecs available with low-complexity compression enhancement methods able to reduce bitrate and produce layers of data that can be discarded on the fly in case of sudden congestion. Notice that an example of such methods is already available with the MPEG-5 LCEVC (Low Complexity Enhancement Video Coding) coding enhancement standard, which improves compression efficiency, reduces overall processing requirements and generates a layer of enhancement data that can be dropped in case of sudden network congestion without compromising decoding of the base layer video, therefore reducing the risk of latency jitter.
3. Strong network backbone/CDNs/wireless in place between the rendering and XR display device, and sufficient cloud rendering resources available (e.g. “CRNs”) .
   With split computing, the non-negotiable quality of experience may be at risk if the network and the shared resources are not robust. Telco operators, cloud providers and CDNs will have to work extra hours to make sure that as many people as possible find themselves in the condition highlighted in point 2 above, where a user has access to a powerful GPU server somewhere within a few milliseconds of network ping and an end-to-end reliable connection of at least 30-50 Mbps is available. Currently less than 10% of the population of developed countries are subscribed to FTTH-grade connectivity and installed latest-generation Wi-Fi routers. In addition, the GPU server infrastructure available in the cloud would be capable of supporting just a fraction of them.

### The Case for Low-Complexity Layered Encoding

LCEVC is ISO-MPEG's new hybrid multi-layer coding enhancement standard. It is codec-agnostic in that it combines a lower-resolution base layer encoded with any traditional codec (e.g., h.264, HEVC, VP9, AV1 or VVC) with a layer of residual data that reconstructs the full resolution. The LCEVC coding tools are particularly suitable to efficiently compress details, from both a processing and a compression standpoint, while leveraging a traditional codec at a lower resolution effectively uses the hardware acceleration available for that codec and makes it more efficient.

LCEVC is proposed as a key enabler of ultra-low-latency XR streaming, producing benefits such as the following:
1. Remarkable compression benefits for all available hardware codecs (h.264, HEVC or AV1). The LCEVC compression enhancement toolkit mostly operates in the spatial domain and its benefits are therefore very effective for ultra-low-latency coding whereby definition most temporal compression techniques (such as pyramids of bi-predicted references leveraging subsequent frames) can't be employed. Aside from efficiency gains relative to non-enhanced encoding being material (typically above 30-40%), what matters is that with LCEVC the absolute bandwidth can fit within the constraints. LCEVC enables high-framerate stereoscopic 4K within 25-50 Mbps, making high-quality wireless casting and cloud XR streaming substantially more viable. The difference in subjective quality around 30 Mbps often means the difference between “unwatchable” vs. “fit for purpose”.
2. Unique reduction of latency jitter thanks to the multi-layer structure inherent in LCEVC. The LCEVC data can be transmitted in a separate lower-priority data channel and dropped on the fly—even in the middle of frame transmission, after encoding—in case of network congestion, without compromising the base layer and with minimal impact on visual quality (i.e., picture quality will look softer for a couple of frames, without evident space-correlated impairments). This enables immediate handling of the frequent oscillations and packet loss inherent in wireless transmission, avoiding piling up tens of milliseconds of latency jitter at every sudden drop of bandwidth. Additionally, from an overall end-to-end system latency point of view, LCEVC enables transmission and decoding of the base layer while still encoding the enhancement layer, providing an additional degree of freedom to reduce coding latencies.
3. Low processing complexity, allowing LCEVC to be immediately used via efficient heterogeneous processing (e.g., 4K 72 fps with limited resource overhead vs. native hardware encoding/decoding), and—in case of dedicated silicon acceleration, wth IP blocks already available—making it possible to efficiently encode/decode extremely high resolutions, frame rates and bit depths (e.g., 16 K 120 fps 14-bit) with a very small silicon footprint, enabling retina-display XR streaming quality wirelessly on lightweight devices.
4. High bit-depth High Dynamic Range (HDR). HDR is important for realistic immersive experiences, and from previous analyses the higher the bit-depth, the better. LCEVC leverages 16-bit accelerated pipeline, so it can encode HDR video at 12-bit or 14-bit without any processing and/or bitrate overhead, while still using the available 8-bit or 10-bit base layer codecs.
5. Ability to send 14-bit depth maps along with the video, enabling more realistic depth-based reprojection and eye-tracking-based varifocal adjustments, for better overall visual experience. In the absence of depth maps, the reprojection executed immediately before display—to compensate for the difference between the actual viewport and the viewport forecast during rendering—is performed by means of a “flat” reprojection. This is one of the main visual impairments generated by system latency. Availability of depth maps will also be useful with eye tracking and upcoming varifocal headsets, to know on the local device what is the depth of the VR object watched by the user and adjust accordingly the display focal length to avoid the vergence accommodation conflict (i.e., a major step towards visual realism). The fast software-based coding tools of LCEVC (performed via 16-bit accelerated pipelines) enable effective delivery of depth maps along with the video, whenever sufficient resources and/or bandwidth are available. Along with making video+depth practical from a processing standpoint, the overall bandwidth reduction enabled by LCEVC is also critical to allowing depth map transmission within the available bandwidth constraints.

Importantly, the above benefits can be achieved while keeping average system latency to a minimum. Since LCEVC natively splits the computation in separate independent processes (similar to a sort of “vertical striping”) without compromising compression efficiency, it is possible to structure the end-2-end pipeline for maximum parallel execution, as illustrated in FIG. 7.

Suitable ultra-low-latency implementation of LCEVC-enhanced casting can thus produce a beneficial combination of visual quality enhancement, minimum average latency and reduction of latency jitter, making the case for local and/or cloud-based split computing with “retina quality” 120 fps wireless XR streaming to lightweight devices. That would be an example of what we call “making the future of digital come alive”, enabling creatives and digital businesses alike to design a whole new world of impactful experiences and user interfaces.

Further elaborating on the multi-layer and low-complexity coding toolkit of LCEVC, SMPTE VC-6 (SMPTE ST 2117-1) is another coding standard particularly suited for Metaverse datasets, thanks to its recursive multi-layer scheme, the use of S-trees and its extensible coding toolkit, which uniquely includes massively parallel entropy coding and in-loop neural networks. Concepts of VC-6 are illustrated in FIG. 8.

Aside from its applications in image/texture compression, professional video workflows and Al media indexing acceleration, a variant of VC-6 for point cloud compression was used to compress the PresenZ volumetric video format, the only media format capable of rendering photorealistic 6DoF volumetric experiences. This is described in WO 2023/047119, which is incorporated herein by reference. Several examples of media using the PresenZ player and benefitting from this compression are available in the Steam Store. Uniquely, the codec didn't just compress the huge data set (50+ Gigabits-per-second) to make it deliverable to end users, it also demonstrated extra-fast software decompression, by decoding it in real-time while leaving enough free processing resources for high-resolution high-framerate real-time rendering.

In the Metaverse, 3D-object decompression, graphics rendering and viewport compression are all going to be closely linked. In such circumstances, hierarchical data structures are particularly advantageous. When using a hierarchical data structure, a higher quality texture or polygon model can be obtained from the lower quality version, adding some data that specify details. As you get closer to an object, you fetch more data. Further, if decoding is extra-fast and massively parallel, it may be preferable to operate directly on compressed rather than uncompressed data, maximizing the level of realism that can be handled with a given memory bandwidth.

On top of these benefits, hierarchical multi-layer signal formats can also assist in the world of AI-based indexers, making them more accurate and faster in classification tasks, which is of great benefit to metaverse bots. Lower quality signal renditions allow to rapidly detect the areas that require further classification, and region-of-interest high-resolution decoding can be completed only for the areas that are of particular interest, with multiple classifiers operating differently and in parallel on a same compressed data set, possibly distributed across multiple nodes.

Data types are likely to increase in the metaverse: specific applications will require their own mix of point clouds, meshes, ancillary data for physics rendering engines, textures and augmented video. They will require forms of progressive and region-of-interest partial decoding. They may have to work on data with variable bit depth, sometimes higher than 10 bit (e.g., for depth maps, or point cloud coordinates).

Low-complexity multi-layered coding, able to efficiently execute in software on general purpose parallel hardware, is proposed as a scalable solution, interoperable with a variety of devices with different display screens and processing power. Flexibility is desirable, for example to enable similar coding schemes to run both as ASICs/FPGAs with very low gate count and as software on general-purpose graphics hardware at low processing power consumption.

Such design criteria are core to video standards MPEG-5 LCEVC and SMPTE VC-6, while the MPEG Immersive Video (“MIV”) and volumetric data compression projects within MPEG may be also useful for addressing some of these issues. Suitably leveraging on these latest coding standards can make high-quality XR feasible and interoperable.

Placing fiber cables down, rolling out 5G and putting up new data centers is also a must, but by itself it cannot solve the issue. All available tricks will have to be used.

### More Quality with Less Energy

Sustainability is also a consideration. In a nutshell, we need compelling, disruption-free, XR workflows and energy bills kept to a minimum.

It's very difficult to provide reliable numbers, and laudable initiatives like Greening of Streaming are springing up to provide more clarity on what to measure and how to measure it. That said, the environmental impact of media delivery is certainly relevant and fast-growing. Around 2% of global greenhouse gas emissions come from data centers, and they use approximately 200 terawatt-hours of electricity, which is equivalent to the global airline industry. When this energy consumption is taken and added to the remaining delivery elements of video streaming, plus we account for 50% growth rate per year in usage, plus remembering that Moore's law is no longer going to help much in terms of power consumption per unit of processing, plus adding the Metaverse to the mix ... that number is poised to soon become a double-digit percentage of total global energy consumption.

Since XR rendering and video casting are often 1:1 operations, power usage may grow linearly with users, differently from broadcasting and video streaming: low-processing approaches are likely to be important to the overall sustainability of the Metaverse, adding one more brick in building the case for low-complexity multi-layered coding.

### Making the Metaverse a Reality

The ever-expanding volume of diverse 3D data and the tight video streaming constraints of split computing are the key challenges to address to ensure that immersive worlds can be delivered to end users interoperably and at scale.

As highlighted above, rapidly adopting available multi-layer coding standards as well as developing new ones from the same IP/toolkits can materially accelerate the development of high quality and interoperable Metaverse destinations.

The ability to suitably tackle the data volume challenges, promptly leveraging on the approaches and standards that are available, will be one of the key factors driving the speed with which the XR meta-universe is brought to the masses.

1. A networked system for generating a sequence of frames for rendering a dynamic 3D scene, the system comprising a first rendering node and a second rendering node, wherein:
the first rendering node is configured to:
generate a sequence of first partially rendered frames; and
perform layered encoding on each first partially rendered frame to generate a sequence of encoded first partially rendered frames; and
transmit the sequence of encoded first partially rendered frames to the second rendering node; and
the second rendering node is configured to:
obtain the sequence of encoded first partially rendered frames from the first rendering node; and
generate a sequence of second partially or fully rendered frames based on the sequence of encoded first partially rendered frames.

2. A networked system according to 1, wherein the second rendering node is configured to decode the sequence of encoded first partially rendered frames to obtain the sequence of first partially rendered frames.

3. A networked system according to claim 1 or claim 2, wherein the second rendering node is configured to perform layered encoding on each second partially or fully rendered frame to generate a sequence of encoded second partially or fully rendered frames.

4. A networked system according to claim 3, wherein the first rendering node is configured to perform layered encoding according to a first coding scheme, and the second rendering node is configured to perform layered encoding according to a second coding scheme, the first coding scheme being different from the second coding scheme.

5. A networked system according to any of claims 1 to 4, wherein a frame rate for the sequence of second partially or fully rendered frames is greater than a frame rate for the sequence of first partially rendered frames.

6. A networked system according to any of claims 1 to 5, comprising a display device, wherein a communication delay between the first rendering node and the display device is larger than a communication delay between the second rendering node and the display device.

7. A networked system according to claim 6, wherein:
the first rendering node is configured to obtain a viewing position from the display device before generating the sequence of first partially rendered frames; and
the second rendering node is configured to obtain an updated viewing position from the display device before generating the sequence of second partially or fully rendered frames.

8. A networked system according to any of claims 1 to 7, wherein generating the sequence of first partially rendered frames requires greater processing resources than generating the sequence of second partially or fully rendered frames.

9. A networked system according to any of claims 1 to 8, wherein each frame comprises image data and depth map data, and the system comprises a third rendering node configured to generate a sequence of third fully rendered frames by performing time warping and/or depth correction on the sequence of second partially or fully rendered frames using the depth map data.

10. A networked system according to any of claims 1 to 9, wherein each frame comprises point cloud data in which each of a plurality of points has a 3D position and one or more attributes.

11. A networked system according to claim 10, wherein the second rendering node or a third rendering node is configured to calculate depth map data based on 3D positions of points.

12. A networked system according to any of claims 1 to 11, wherein:
the first rendering node is configured to generate one or more sequences of first partially rendered frames, for a first number of users or display devices; and
the second rendering node is configured to generate one or more sequences of second partially or fully rendered frames, for a second number of the plurality of users or display devices, wherein the second number is smaller than the first number.

13. The networked system of any of claims 1 to 11, wherein the networked system dynamically chooses how many nodes and what specific nodes will be used for the rendering process responsive to at least one metric comprising:
a metric based on complexity of the rendering task to be performed,
a metric based on the spare capacity available in each node,
a metric based on the location of the display device with respect to the network of nodes,
a metric based on the roundtrip latency between nodes and display device,
a metric based on the bandwidth available among nodes and from nodes to display device, and
a metric based on the number of distinct display devices requesting rendering of a same 3D scene within a range of point of views.

14. The networked system of any of claims 1 to 13, wherein a partially rendered frame is encoded as volumetric data comprising one or more of:
point cloud data,
mesh data,
texture data.

15. The networked system of any of claims 1 to 14, wherein a partially rendered frame comprises light field data.

16. The networked system of any of claims 1 to 15, wherein a partially rendered frame comprises spatial properties allowing to compute the behaviour of sound in the 3D space.

17. The networked system of any of claims 1 to 16, the partially rendered frame is encoded by using at least in part lossy encoding methods.

18. The networked system of any of claims 1 to 17, wherein a partially rendered frame is encoded by using at least in part layered encoding methods.

19. The networked system of any of claims 1 to 18, wherein a subsequent node receives only a portion of the data encoded by the first rendering node, responsive to the specific location of the one or more points of view of the fully rendered frames to be computed.

20. The networked system of any of claims 1 to 19, wherein a subsequent node only decodes the subset of encoded data produced by the first rendering node and received by the subsequent node that are necessary to fully render the specific field of view that it is rendering at any one point.

21. The networked system of any of claims 1 to 20, wherein a partially rendered frame is encoded by using at least in part a point cloud format representing points according to one or more coordinate systems, each point being attributed one or more data attributes specifying visual properties comprising one or more of size, normal vector, motion information, colour information, transparency.

22. A method for encoding a sequence of frames representing a dynamic 3D scene, wherein each frame is composable from base-layer image data and enhancement data, the method comprising: performing layered encoding on a frame of the sequence of frames to generate an encoded frame comprising one or more of a base image layer and an enhancement image layer.

23. The method of claim 22, wherein the enhancement image layer comprises data used by the decoder device to reconstruct a higher resolution rendition of the sequence of frames.

24. The method of claim 22 or claim 23, wherein the enhancement image layer comprises data used by the decoder device to reconstruct a higher bit-depth rendition of the sequence of frames with respect to the bit-depth of the base image layer.

25. The method of any one of claims 22 to 24, wherein the enhancement image layer comprises data used by the decoder device to reconstruct the distance of objects in the image from the viewer.

26. The method of any one of claims 22 to 25, the enhancement image layer comprises data used by the decoder device to reconstruct haptic feedback for the user.

27. The method of any one of claims 22 to 26, the method further comprising:
responsive to a drop in transmission channel bandwidth, discarding enhancement data during transmission of the sequence of frames and indicating to the encoder that the enhancement data has been dropped, and if the enhancement data is being dropped, refreshing temporal buffers of enhancement data encoding and performing an Instantaneous Decoder Refresh (IDR) for the enhancement data (not necessarily for the base layer data), to account for the decoder having missed some of the previous enhancement data.

28. The method of any one of claims 22 to 27, wherein the layered encoding method used is MPEG-5 LCEVC (Low Complexity Enhancement Video Coding) encoding or SMPTE VC-6 encoding.

29. The method of claim 28, wherein at least one of the enhancement data being transmitted as embedded user data within the coefficients of LCEVC data.

30. The method of claim 29, wherein one or more residual coefficients of an image comprise embedded depth information representing the depth of the corresponding object with respect to the viewpoint, and the decoder processes the embedded data to reconstruct a depth map associated to the image frame based at least in part on the embedded data.

31. The method of claim 30, wherein the depth map is reconstructed by processing both the embedded data and the image data.

32. The method of any one of claims 22 to 31, wherein the frame plus depth data sent at a given frame rate are used by a display device to increase the frame rate via depth-based reprojections so as to match a display frame rate.

33. The method of any one of claims 22 to 32, wherein each frame comprises image data and depth map data and the method comprises:
performing layered encoding on a frame of the sequence of frames to generate an encoded frame comprising one or more of a base depth map layer and an enhancement depth map layer.

34. A method according to claim 33, wherein each frame comprises an image layer and a depth map layer, and the encoded frame comprises one or more of a base image layer, the base depth map layer, an enhancement image layer and the enhancement depth map layer.

35. A method according to claim 33, wherein each frame comprises the depth map data embedded in the image data, the base depth map layer is a base image layer with embedded depth map data, and the enhancement depth map layer is an enhancement image layer with embedded depth map data.

36. A method according to any of claims 33 to 35, further comprising:
receiving a depth map drop indication indicating whether or not the depth map data is being dropped when transmitting the sequence of frames; and
if the depth map data is being dropped, discarding the depth map data of a frame, and performing layered encoding on the image data of the frame to generate an encoded frame comprising a base image layer and an enhancement image layer.

37. A method comprising:
receiving a frame plus depth data at a given frame rate, encoded by means of a layered encoding method;
at a display device, increasing the frame rate via depth-based reprojections using the depth data so as to match a display frame rate.

38. The method of claim 37, wherein the frame comprises data representing a dynamic 3D scene, and each frame comprises base-layer image data and enhancement data, the method comprising:
performing layered decoding on a frame of the sequence of frames to generate a decoded frame from an encoded frame comprising a base image layer and an enhancement image layer.

39. A bit sequence representing an encoding of a sequence of frames representing a dynamic 3D scene, the bit sequence comprising one or more of:
encoded data for a base depth map layer for a frame; and
encoded data for an enhancement depth map layer for the frame.

40. A bit sequence according to claim 39, further comprising one or more of:
encoded data for a base image layer for the frame; and
encoded data for an enhancement image layer for the frame.

41. A bit sequence according to claim 39, wherein the base depth map layer is a base image layer with embedded depth map data, and the enhancement depth map layer is an enhancement image layer with embedded depth map data.

42. A method for transmitting a sequence of frames representing a dynamic 3D scene, wherein each frame comprises image data and depth map data, the method comprising:
obtaining an encoded frame comprising one or more of a base depth map layer and an enhancement depth map layer;
determining if the depth map data is to be dropped when transmitting the sequence of frames;
if the depth map data is to be dropped:
discarding the depth map data from the encoded frame, to give a reduced encoded frame comprising one or more of a base image layer and an enhancement image layer; and
transmitting the reduced encoded frame; and
otherwise, transmitting the encoded frame.

43. A method according to claim 42, wherein:
each frame comprises an image layer and a depth map layer,
the encoded frame comprises one or more of a base image layer, the base depth map layer, an enhancement image layer and the enhancement depth map layer, and
discarding the depth map data comprises discarding the enhancement depth map layer, and preferably further comprises discarding the base depth map layer.

44. A method according to claim 42, wherein:
each frame comprises the depth map data embedded in the image data,
the base depth map layer is a base image layer with embedded depth map data, and the enhancement depth map layer is an enhancement image layer with embedded depth map data, and
discarding the depth map data comprises removing the embedded depth map data from the enhancement image layer, and preferably further comprises removing the embedded depth map data from the base image layer.

45. A method according to any of claims 42 to 44, further comprising:
generating a depth map drop indication indicating whether or not the depth map data is being dropped when transmitting the sequence of frames; and
sending the depth map drop indication to an upstream encoder, or sending the depth map drop indication with the encoded frame or the reduced encoded frame.

46. A method performed by an encoder for encoding a sequence of frames, the method comprising:
performing layered encoding on a first frame of the sequence of frames to generate a first encoded frame comprising a base layer and an enhancement layer;
storing a component of the enhancement layer of the first encoded frame in a temporal buffer, for use in temporal encoding of a subsequent frame;
sending the first encoded frame to a transmitter for transmission;
receiving an enhancement drop indication indicating whether or not the enhancement layer was dropped when transmitting the first encoded frame;
performing layered encoding on a second frame of the sequence of frames to generate a second encoded frame comprising a base layer and an enhancement layer, wherein:
if the enhancement drop indication indicates that the enhancement layer was not dropped, the enhancement layer of the second encoded frame is generated with reference to the temporal buffer, and
if the enhancement drop indication indicates that the enhancement layer was dropped, the enhancement layer of the second encoded frame is generated without reference to the temporal buffer.

47. A method according to claim 46, further comprising, if the enhancement drop indication indicates that the enhancement layer was dropped, clearing the temporal buffer.

48. A method according to claim 46 or claim 47, further comprising:
if no enhancement drop indication is received within a predetermined time limit, performing layered encoding on a second frame of the sequence of frames to generate a second encoded frame comprising a base layer and an enhancement layer, wherein the enhancement layer of the second encoded frame is generated with reference to the temporal buffer.

49. A method according to claim 46 or claim 47, further comprising:
if no enhancement drop indication is received within a predetermined time limit, performing layered encoding on a second frame of the sequence of frames to generate a second encoded frame comprising a base layer and an enhancement layer, wherein the enhancement layer of the second encoded frame is generated without reference to the temporal buffer.

50. A method according to any of claims 46 to 49, wherein generating the enhancement layer of a frame without reference to the temporal buffer comprises:
decoding the base layer of the encoded frame; and
calculating a residual as a difference between the decoded base layer and the frame.

51. A method according to any of claims 46 to 50, wherein generating the enhancement layer of a frame with reference to the temporal buffer comprises:
decoding the base layer of the encoded frame;
calculating a residual as a difference between the decoded base layer and the frame; and
calculating a difference between the residual of the current frame and a corresponding residual of a previous frame stored in the temporal buffer.

52. A method according to any of claims 46 to 51, wherein the layered encoding is LCEVC encoding.
